(19) United States
(12) Patent Application Publication
(10) Pub. No.: US 2022/0334080 A1
(43) Pub. Date: Oct. 20, 2022

(54) ION MOBILITY SPECTROMETRY

(71) Applicant: Thermo Fisher Scientifc (Bremen) GmbH, Bremen (DE)

(72) Inventors: Alexander Makarov, Bremen (DE); Dmity GRINFELD, Bremen (DE)

(21) Appl. No.: 17/658,345

(22) Filed: Apr. 7, 2022

(30) Foreign Application Priority Data
Apr. 13, 2021 (GB) 2105251.9

(51) Int. Cl. G01N 27/623; H01J 49/16; H01J 49/42

(52) U.S. Cl. CPC G01N 27/623; H01J 49/165; H01J 49/4215

(57) ABSTRACT

A method of ion mobility spectrometry and an ion mobility spectrometer. The method comprises introducing a packet of sample ions into a chamber, the sample ions including an ion for analysis and the chamber housing a drift region and a deflection region. The sample ions are passed on a drift trajectory through the drift region towards the deflection region, wherein the sample ions separate according to their ion mobility as they pass through the drift region. The sample ions received from the drift region are then passed on a deflection trajectory through the deflection region whilst changing the direction of the sample ions on the deflection trajectory to travel towards the same drift region or a further drift region.

### CROSS-REFERENCE TO RELATED APPLICATIONS

The present application claims priority benefit under one or more of 35 U.S.C. 119(a)-119(d) of GB Patent Application No. 2105251.9, filed Apr. 13, 2021, which is hereby incorporated by reference herein in its entirety for all purposes.

### FIELD OF THE INVENTION

This invention relates to apparatus and methods for ion mobility spectrometry (IMS), including ion mobility spectrometers. The apparatus and methods may be suitable for use in combination with mass spectrometry (MS), for instance in hybrid IMS/MS instruments.

### BACKGROUND TO THE INVENTION

Ion-mobility spectrometry (IMS) is an analytical technique used to separate and identify ionized molecules in the gas phase based on their mobility in a carrier buffer gas. IMS instruments may be used alone, or be coupled with mass spectrometry, gas chromatography or high-performance liquid chromatography for further analysis of the separated ions.

The basic principle of ion mobility spectrometry measures the time taken for sample ions to traverse a given length, L, (a drift length of a drift tube 20 as shown in FIG. 1) in a uniform electric field, E, creating a potential gradient and through a given buffer gas 26 (also known as a drift gas). Collisions of the sample ions with the buffer gas 26 slow the progress of the ions through the drift tube 20 and cause the ions to lose energy. The ions lose energy at a rate that is dependent on their ion mobility. Therefore, the sample ions separate according to their mobility, with ion species with higher mobility 22 traversing the drift length L more quickly than ion species with lower mobility 24. Specifically, ion mobility K can then be experimentally determined from the drift time t_{D} of an ion traversing within a homogeneous electric field the potential difference U in the drift length L.

$$K = \frac{{L}^{2}}{{t}_{D} U}$$

In order to achieve a high resolution of mobility separation at relatively low pressures, a relatively long drift tube must be employed in order to keep within the low field limit.

In some prior art systems, the drift tube comprises a radio frequency (RF) ion guide, and an axial direct current (DC) electric field may be generated which is orthogonal to the RF radial confinement. If a constant axial electric field E is applied in order to drive ions along and through an ion guide containing a gas, then the ion will acquire a characteristic velocity, v:

v=EK

wherein K is the ion mobility.

To maintain ion mobility separation in the so-called low field regime (whereby ions do not receive kinetic energy from the driving field), the ratio of E to the pressure of the background gas P should maintained at a value less than about 200 Vm⁻¹ mbar⁻¹. At the same time, resolving power R of ion mobility separation (denoted by the full width half maximum of the ion peaks) is limited by diffusion, and could be approximately estimated at full-width half-maximum (FWHM) as:

$$R = \frac{1}{2} \sqrt{\frac{e z E L}{k T}}$$

wherein z is the charge state of ions, L is the length of separation (in other words, the length of the drift tube or drift phase), T is temperature of background gas, e is elementary charge (1.602×10⁻¹⁹ C) and k is Boltzmann's constant (1.38×*10⁻²³ JK⁻¹). More accurate calculations can be found in G. E. Spangler, Int. J. Mass Spectrom., 220, (2002), p 399-418.

An increase in electric field E is limited by low-field conditions and a decrease in temperature T is associated with cumbersome cryogenic techniques. Therefore, the most practical approach to increase the resolving power R is to increase the drift length, L. How to provide such an increase of length L within the space constraints of typical laboratory equipment is a problem addressed by this invention.

Various approaches to increase the drift length L have been previously proposed. For example, arrangements of the IMS described in Patent Publications WO 2008/104771, GB 2447330 and GB 2457556, US 2012/15314 and US 2020/006045 provide a helical or coiled drift tubes, thereby increasing length L within a compact space. However, these solutions also increase the complexity and manufacturing cost of the device.

Another compact device is provided by a multi-turn (racetrack) configuration described in Patent Publication Nos. WO 2008/028159, U.S. Pat. Nos. 8,513,591, 9,429,543 and 9,552,969. In the IMS system described in patent Publication No. U.S. Pat. No. 9,552,969, although the resolving power is much improved, only a narrow range of ion mobilities are retained on the circular trajectory.

In an alternative approach, Patent Publication No. US 2016/084799 disclosed a multi-reflection system including a drift tube arranged between low-pressure reflection regions at each end. Reflection of ions can occur in the low-pressure regions so that ion packets can be passed back and forth within the same drift tube, thereby increasing the overall length L. However, the pumping requirements for this system place constraints on the shape, size and configuration of the IMS, and increases its complexity for arrangement together with other laboratory equipment.

Accordingly, the present invention looks to solve some of these drawbacks of prior art devices.

### SUMMARY OF THE INVENTION

In a first aspect there is a method of ion mobility spectrometry comprising:

introducing a packet of sample ions into a chamber, the sample ions including an ion for analysis and the chamber housing a drift region and a deflection region;

passing the sample ions on a drift trajectory through the drift region towards the deflection region, wherein the sample ions separate according to their ion mobility as they pass through the drift region; and

passing the sample ions received from the drift region on a deflection trajectory through the deflection region whilst changing the direction of the sample ions on the deflection trajectory to travel towards the same drift region or a further drift region; wherein the chamber is maintained at a pressure that is substantially homogeneous throughout the chamber, the pressure being such that the mean free path of the ion for analysis is greater than the length of the deflection trajectory, and less than the length of the drift trajectory.

Ion mobility spectrometry may be used to separate ions of different ion mobility. Separated ions may be ejected, successively, from the ion mobility chamber, and in some examples, the ejected ions may be passed to an analyser (such as a mass analyser) for further analysis.

The packet of sample ions comprises various ions having different ion mobility. The packet of sample ions may have been formed via ionisation of a sample prior to entry to the IMS chamber. Ions of interest within the packet of sample ions are ions the user wishes to select for use in onward analysis or processing. A given species of ion of interest will have a common ion mobility, and therefore can be separated from the rest of the packet of sample ions and subsequently ejected from the chamber (perhaps to an analyser). A packet of sample ions may initially comprise one or more ions of interest, as well as ions not of interest. Different ions of interest may be of different species, separable according to their ion mobility.

The chamber comprises or defines a single cavity therein, which houses or contains the deflection region and the drift region. The deflection region is contiguous with the drift region within the chamber. The chamber typically does not comprise any narrow aperture or significant physical barriers between the drift region and any deflection region. In this way, the chamber is maintained at a pressure that is substantially homogeneous throughout the chamber.

The deflection region may be defined as a portion of the chamber in which an applied electric field gives rise to a change of direction and/or acceleration of the sample ions. The deflection trajectory is the pathway of a sample ion through the deflection region. In contrast, in the drift region an ion experiences an axial electric field, causing the sample ion to move along a relatively straight trajectory (which is the drift trajectory, in the drift direction). Ions are received into a deflection region from a drift region, and pass out of the deflection region into the same, or a different, drift region.

In use, the chamber is filled with a drift gas (necessary for ion mobility separation in the drift region). Examples of suitable drift gases include helium, nitrogen, argon, air, and carbon dioxide, as well as other possible drift gases. Mixtures of any two or more of these drift gases (for instance, a He/N₂ mixture) could also be used. The pressure is substantially the same (uniform) across the whole chamber. In other words, there is no substantial difference in the pressure between the deflection regions and the drift region(s). Although some small pressure differences may occur in the chamber as a result of the geometry of the chamber and any slight restrictions imposed by the position of electrodes, especially with respect to the position of any pumping outlet, these differences will be insignificant compares to the absolute average pressure in the chamber. The pressure across the whole chamber is within the same order of magnitude, as discussed in more detail below.

The chamber may be pumped through a single pump outlet, that serves the whole chamber, or via multiple pump outlets. Pumping may take place through the ion inlet and/or the ion outlet only, without a separate dedicated pump outlet. The chamber may be pumped using a single pump connected to a single pump outlet to the chamber, or connected to multiple interconnected pump outlets from the chamber. Use of a single pump causes the chamber to be pumped to a substantially homogenous pressure throughout (although use of a single pump is not essential, and a substantially homogenous pressure in the chamber could be achieved in other ways),

The pressure in the chamber should be such that the mean free path of the ion for analysis is greater than the length of the deflection trajectory of the ion for analysis (i.e. greater than the length of the path of the ion for analysis through the deflection region), and less than the length of the drift trajectory of the ion for analysis (i.e. less than the length of the path of the ion for analysis through the drift region). The mean free path of the ion for analysis, mfpᵢₒₙ, corresponds to the distance for the ion for analysis to lose momentum to 1/e (approximately 1/2.71828) of its original momentum, the ion for analysis having a cross-section σ. In other words:

$$m f {p}_{i o n} = ( \frac{M + m}{m} ) ( \frac{1}{n \sqrt{{σ}^{2} + {σ}_{ℊ}^{2}}} )$$

where m is the mass of a drift gas molecule, M the mass of an ion for analysis, and σ_{g} is the cross-section of a drift gas molecule. By way of explanation, this is different from the mean free path, λ, of gas molecules of cross-section σ_{g} at concentration n, where

$$λ = \frac{1}{n {σ}_{ℊ} \sqrt{2}} .$$

This measure of mean free path, λ, typically is not appropriate for use in to the context of the present invention (which concerns movement of ions).

In contrast, the stopping length, stopLᵢₒₙ, of the ion for analysis could be considered as a direct alternative to the mean free path of the ion for analysis, mfpᵢₒₙ, in the context of the present invention. The stopping length, stopLᵢₒₙ, is the path length over which a complete loss of momentum is experienced by the ion for analysis, so that the ion is subsequently thermalized to energy kT (where k is Boltzmann's constant, and T is the temperature of the ion for analysis). The stopping length stopLᵢₒₙ for an ion of mass M and initial velocity u in buffer gas of mass m, density n, average thermal velocity v and cross-section a can be calculated approximately as

$$stop {L}_{i o n} = m f {p}_{i o n} \cdot constant = \frac{M + m}{mn σ} \cdot \frac{3 √ 5}{4} arctan ( \frac{u}{v √ 5} )$$

(see A. V. Tolmachev et al., NIM Phys Res. B, 124 (1997) 112-119).

In an ideal configuration of the present invention, the movement of the ion for analysis will be ballistic through the deflection regions (in other words, the ion for analysis would more though the deflection regions without experiencing a collision with a drift gas particle). However, the motion of the ion for analysis through the drift region(s) should be diffusive or quasi ballistic, such that the ion for analysis experiences a number of collisions whilst passing on the drift trajectory.

Preferably, the pressure throughout the chamber is substantially homogenous, such that the pressure throughout the chamber or in all regions of the chamber has the same order of magnitude. The pressure at the region of the chamber having highest pressure is no more than 10 times the pressure at the region of the chamber having lowest pressure, and more preferably no more than 5 times, or more preferably no more than 2 times. The change of pressure over the length of one mean free path of the ion for analysis is much smaller than the magnitude of the average pressure in the chamber, the change in pressure being less than a) 10%, b) 5% or c) 2% of the magnitude of the average pressure. The pressure throughout the chamber may have an absolute pressure gradient of less than 0.1 across the chamber, and more preferably an absolute pressure gradient of less than 0.05 across the chamber. The pressure in the chamber has an absolute pressure gradient of magnitude less than 10 fold across the chamber (in other words, in the drift region compared to the deflection region), and preferably an absolute pressure gradient of magnitude less than 5-fold across the chamber, and more preferably an absolute pressure gradient of magnitude less than 2-fold across the chamber. The pressure gradient or to profile throughout the chamber may be smooth, without large, sharp steps in the pressure between any adjoining regions within the chamber.

As noted above, in an ideal configuration of the present invention, the movement of the ion for analysis will be ballistic through the deflections region (in other words, the ion for analysis would more though the deflection region without experiencing a collision with a drift gas particle). However, the motion of the ion for analysis through the drift region(s) would be diffusive or quasi ballistic, such that the ions for analysis experience a number of collisions whilst on the drift trajectory. For ballistic operation in the deflection regions in all described configurations of the invention, pressure is preferably sustained in the range 0.001 to 1 mbar, or 0.001 to 0.5 mbar, or 0.001 to 0.1 mbar, or 0.005 to 1 mbar, or 0.005 to 0.5 mbar, or 0.005 to 0.1 mbar, or 0.01 to 1 mbar, or 0.01 to 0.5 mbar, or 0.01 to 0.1 mbar.

Preferably, the method further comprises accelerating the sample ions upon entry to the deflection region. Acceleration of the sample ions may take place prior to, or simultaneously with, the changing the direction of the sample ions. As ions reach the deflection region, they will be thermalized (in other words, have an energy comparable to kT). The ions may be accelerated to increase the magnitude of their energy, such that although absolute energy spread will increase, the relative spread in the energies of the ions of similar mobility (considered relative to their overall energy) is decreased. Accordingly, acceleration spatially focusses the ions (of a given portion of the sample ions having similar mobility) and so avoids losses upon change of direction of the ions in the deflection region. It is not essential to accelerate the ions entering the deflection region, but without acceleration either the radius of the turn of the deflection would need to be increased by orders of magnitude, or the pressure in the chamber would need to be increased correspondingly. Such options are not optimal, given the other design considerations for the described ion mobility spectrometer.

Preferably, the sample ions are accelerated to an energy greater than, and preferably much greater than, kT, where k is the Boltzmann constant and T is temperature, but below the fragmentation energy of the sample ions. Optionally, the sample ions may be accelerated to an energy more than two times, more than three times, more than four times, more than five times, or more than ten times kT. In an example, acceleration of the sample ions may result in an increase of energy of the sample ions by between 2 eV and 8 eV, or more preferably by between 3 eV and 6 eV. Sample ions of this energy have an energy that is high enough to control ions and transmit them with superior (up to 100%) efficiency, but an energy that is low enough to avoid fragmentation. Preferably, the sample ions are accelerated by application of an accelerating electric potential of between 1 and 8 V, or preferably between 2V and 8V, or more preferably between 2 V and 6 V. The accelerating electric potential may be mass-dependent on the sample ions, for instance being below 10-30 V per 1000 Thomson (where Thomson is a unit of mass-to-charge ratio) and dependent on the drift gas (for instance, acceleration of sample ions to a higher energy may be allowed for when using a helium drift gas, than compared to use of heavier drift gases).

Preferably, the ions change direction by application of an electric field having at least a component in an opposite direction to the direction of the drift trajectory and/or in a direction orthogonal to the direction of the drift trajectory. The applied electric potential through the deflection region may be non-linear or linear. A non-linear electric potential applied in the deflection region gives rise to a non-uniform electric field in the deflection region. Said applied electric field causes the sample ions to be deflected off or away from the drift trajectory, to travel in a different direction whilst travelling on the deflection trajectory.

Preferably, a substantially linear electric potential is applied in the drift region creating a uniform electric field in the drift region. Sample ions moving through the drift region as a consequence of the uniform electric field will separate according to their ion mobility. The separation may be of predicable amounts, according to the velocity of the different sample ions. Although the electric potential may be substantially linear (creating a uniform electric field), a non-linear electric potential may be applied in the drift region in order to focus ions and/or avoid losses of ions moving on the drift trajectory.

Preferably, the drift region has a greater extension in a first direction orthogonal to the direction of the drift trajectory than compared to a second direction, also orthogonal to the direction of the drift trajectory, wherein the first and second direction are orthogonal to each other. In other words, the drift region is axially asymmetric. In an example, the extension in the first direction may be twice or more times the second direction. The drift region could also be considered as being defined within the volume of the chamber such that the drift region is a prism with axial symmetry of order 2 around an axis extending in the direction of the drift trajectory. In an example, the drift region has a rectangular or oval cross-section, where the cross-section is perpendicular to the direction of the drift trajectory. As a consequence of the described configuration of the drift region, sample ions moving through the drift region may spread more than in a drift region that is cylindrical (or axially symmetric). This in turn increases the space charge capacity of the drift space, thereby reducing broadening of mobility separated peaks for the same number of sample ions.

Preferably, the or each deflection region has an axially asymmetric configuration similar to the drift region. For example, the or each deflection region may have a greater to extension in a first direction orthogonal to the deflection trajectory than compared to a second direction, also orthogonal to the deflection trajectory, wherein the first and second directions are orthogonal to each other. In this way, sample ions entering the deflection region from the drift region may remain spread as they pass through the deflection region.

Preferably, changing the direction of the sample ions on the deflection trajectory comprises reflecting the sample ions on the deflection trajectory back towards the drift region to travel on a second drift trajectory through the drift region, such that the sample ions pass through the drift region at least twice. In particular, the chamber may house a single drift region extending between a first and second deflection region. Ions received from the drift region at a deflection region are reflected in the deflection region, so as to be passed back into the same drift region but moving in a direction opposite to the direction of movement of the sample ions as they entered the deflection region. Ions can be passed back and forth through the drift region by reflection at the deflection regions at opposing ends. This configuration allows the drift length for ion mobility separation to be increased by passing the ions through the drift region multiple times, without proportionally increasing the size of the chamber.

Preferably, the deflection region is a first deflection region and the chamber further houses a second deflection region, opposite the first deflection region with the drift region extending there between, and wherein the drift trajectory is a first drift trajectory and the deflection trajectory is a first deflection trajectory;

wherein changing the direction of the sample ions on the deflection trajectory comprises reflecting the sample ions on the first deflection trajectory towards the drift region;

the method further comprising:

passing the sample ions on a second drift trajectory through the drift region towards the second deflection region, wherein the sample ions further separate according to their ion mobility as they pass through the drift region on the second drift trajectory; and

passing the sample ions received from the drift region on a second deflection trajectory through the second deflection region whilst reflecting the sample ions on the second deflection towards the drift region;

wherein the chamber is maintained at a pressure such that the mean free path of the ion for analysis is greater than the length of the first or the second deflection trajectory, and less than the length of the first or the second drift trajectory. Again, this describes a configuration for the IMS chamber having a single drift region, with sample ions passed back and forth through the drift region by reflection at opposing deflection regions.

Preferably, the method further comprises passing the sample ions through the drift region and first and second deflection regions multiple times. This increases the effective drift length, without increasing the physical length of the drift region. The ions can be passed through the drift region according to the number of times necessary to achieve the required ion mobility separation of the ions of interest from the rest of the packet of sample ions. In an example, the sample ions may be passed through the drift region three or more times, five or more times, eight or more times, or ten or more times.

Preferably, the drift region is a first drift region and the chamber further houses a second drift region, the deflection region is a first deflection region and the chamber further houses a second deflection region, opposite the first deflection region with the first and the second drift region extending there between and the first and second drift region extending parallel to each other, and wherein the drift trajectory is a first drift trajectory and the deflection trajectory is a first deflection trajectory;

wherein changing the direction of the sample ions on the deflection trajectory comprises changing the direction of the sample ions on the first deflection trajectory to travel towards the second drift region;

the method further comprising:

passing the sample ions on a second drift trajectory through the second drift region towards the second deflection region, wherein the sample ions further separate according to their ion mobility as they pass through the second drift region on the second drift trajectory, and such that sample ions passing through the second drift region on a second drift trajectory travel in a direction that is substantially parallel but opposite to sample ions passing through the first drift region on the first drift trajectory; and

passing the sample ions received from the second drift region on a second deflection trajectory through the second deflection region whilst changing the direction of the sample ions from the second deflection trajectory towards the first drift region;

wherein the chamber is maintained at a pressure such that the mean free path of the ion for analysis is greater than the length of the first or the second deflection trajectory, and less than the length of the first or the second drift trajectory.

In other words, in this configuration the chamber houses a first and a second drift region that extends between a first and the second deflection region, wherein the first and the second drift region are parallel and adjacent to each other. Sample ions passing through the second drift region on the second drift trajectory travel in a direction that is substantially parallel but opposite to sample ions passing through the first drift region on the first drift trajectory. The method may comprise passing or cycling the sample ions through the first and second drift region sequentially, multiple times.

Just as noted above with respect to the example of the IMS system having a single drift region, the method may further comprise accelerating the sample ions upon entry to the first and the second deflection region. In other words, before or simultaneously with the change of direction of the sample ions in the deflection regions, the sample ions may be accelerated. Acceleration spatially focusses the ions and so avoids losses in the deflection region. Preferably, the sample ions are accelerated to an energy greater than, and preferably much greater than, kT, where k is the Boltzmann constant and T is temperature, but below the fragmentation energy of the sample ions.

Preferably, the drift trajectory is a first drift trajectory, the deflection region is a first deflection region, the deflection trajectory is a first deflection trajectory, and the chamber houses at least the first drift region and a second and a third drift region, and the first and a second deflection region, wherein changing the direction of the sample ions comprises:

changing the direction of the sample ions on the first deflection trajectory to travel towards a second drift region;

the method further comprising:

passing the sample ions on a second drift trajectory through the second drift region towards a second deflection region, wherein the sample ions further separate according to their ion mobility as they pass through the second drift region; and

passing the sample ions received from the second drift region on a second deflection trajectory whilst changing the direction of the sample ions on the second deflection trajectory to travel towards the third drift region;

wherein the chamber is maintained at a pressure such that the mean free path of the ion for analysis is greater than the length of the first or second deflection trajectory, and less than the length of the first or second drift trajectory.

In this example of the IMS system, at least three drift regions and corresponding deflection regions are configured within the chamber to allow sample ions to circulate through each of the drift and deflection regions multiple times. For instance, the first drift region may pass sample ions to the first deflection region, the first deflection region may pass sample ions to the second drift region, the second drift region may pass ions to the second deflection region, the second deflection region may pass ions to the third drift region, the third drift region may pass ions to a third deflection region, and a third deflection region may pass ions back to the first drift region. The sample ions can then be circulated multiple times, in order to increase the drift length whilst in a compact configuration for the chamber. Said configuration would be considered as having a duty cycle of three.

Configurations of the IMS system can be envisaged having a duty cycle of 4, 5 or any number, wherein the duty cycle denotes the number of drift and deflection regions within the chamber, joined to form a circular path and to allow circulation of the sample ions multiple times. In all configurations, the pressure in the chamber is substantially homogenous throughout, as discussed above with respect to other arrangements of the system.

Preferably, the method further comprises passing the sample ions through each drift region and each respective deflection region multiple times.

Preferably, for each pass through a given drift region, the sample ions undergo a thermalization phase and a drift phase, and for each pass through a respective deflection region, the sample ions undergo a ballistic deflection phase. During the thermalization phase, the sample ions lose energy via collisions with the drift gas, until reaching an energy of around kT (where k is the Boltzmann constant, and T is the temperature). Sample ions having different ion mobility will undergo separation from each other. During the drift phase, no further energy is lost by the sample ions, but they continue to move through the drift region on the same drift trajectory, and ions of different mobilities continue to separate as a consequence of their different velocity of travel. The sample ions then enter the deflection region, in which electric field is applied to change the direction of the sample ions, and begin a deflection phase. As discussed above, due to appropriate choice of pressure within the chamber, the sample ions moving through the deflection region experience ballistic motion, as the length of the trajectory through the deflection region is greater than the mean free path. As such, the sample ions (or at least, the ions for analysis) on the deflection trajectory undergo a ballistic deflection phase. As the motion through the chamber is cyclical, for each pass through a drift region and respective deflection region, the sample ions (or at least, the ions for analysis) undergo each of these phases: thermalisation phase, drift phase and ballistic deflection phase.

Preferably, the sample ions further undergo an acceleration phase between the drift phase and the ballistic deflection phase. In particular, sample ions are accelerated upon entry to the deflection region. In some cases the acceleration phase at least partly coincides with the ballistic deflection phase.

Preferably, the method further comprises ejecting the ions for analysis out of the chamber. Portions of the sample ions, separated from other sample ions in the original packet of sample ions, may be ejected out of the chamber. In other words, sample ions of specific mobility (for instance, the ions for analysis or ions of interest) may be selected and ejected out of the chamber, for further analysis or use.

Preferably, ions for analysis ejected out of the chamber are passed to a mass analyser. In other embodiments, the ions for analysis may be ejected out of the chamber directly to an ion detector without mass analysis, which may allow ion mobility analysis only.

The packet of sample ions may be introduced into a chamber through a chamber inlet and the ions for analysis may be passed out of the chamber via a chamber outlet. The chamber inlet and the chamber outlet may be the same aperture in the wall of the chamber, or a different aperture. The chamber inlet and the chamber outlet may be arranged in the wall of the chamber in any position relative to each other. Therefore, the chamber inlet and the chamber outlet may be arranged in the wall of the chamber so that sample ions complete a discrete number of cycles (i.e. 3 cycles) when processing between the inlet and the outlet (where a single cycle indicates transmission once through every drift region and deflection region within the chamber). Alternatively, the inlet and outlet may be arranged so that a fraction of the cycle (i.e. 3.5 cycles) is undertaken when processing between the inlet and outlet. The inlet and outlet may be arranged on a different axis to the direction of any drift trajectory through any of the drift regions, as noted in the specific examples described below.

The characteristics of any feature described above with respect to the method will also apply in relation to the characteristics of corresponding features within the described apparatus, such as a ion mobility spectrometer, below.

In a second aspect there is provided an ion mobility spectrometer comprising:

a chamber housing a drift region and a deflection region, the deflection region comprising ion optics to change the direction of ions passing through the deflection region; and

a pump, connected to the chamber for pumping the drift region and the deflection region housed within the chamber;

wherein the drift region is arranged to receive sample ions introduced to the chamber, the sample ions including an ion for analysis, the drift region arranged such that the sample ions pass on a drift trajectory through the drift region and separate according to their ion mobility as they pass through the drift region; and

wherein the deflection region is arranged to receive sample ions from the drift region to travel on a deflection trajectory through the deflection region, and the ion optics are configured to change the direction of the sample ions on the deflection trajectory to travel towards the same drift region or a further drift region;

wherein in use the chamber is maintained at a pressure that is substantially homogeneous throughout the chamber, the pressure being such that the mean free path of the ion for analysis is greater than the length of the deflection trajectory, and less than the length of the drift trajectory.

The chamber defines a volume, in which are arranged at least one drift region, and at least two deflection regions. Each deflection region is contiguous with at least one drift region. In the drift region, an electric field is applied, which causes the sample ions to move through the drift region (which in use is filled with a drift gas) and separate according to their ion mobility. The ion pathway through the drift region is considered a drift trajectory. In the deflection regions, an electric field is applied which causes the sample ions to change direction and move towards either the next drift region, or to be reflected back to the same drift region but moving in the opposite direction. The ion pathway through the deflection region is considered a deflection trajectory.

The chamber is pumped to a substantially homogenous pressure throughout. In other words the pressure in the deflection regions and the drift region(s) is substantially the same. The chamber is pumped via a pump connected to the chamber. The chamber is pumped to a pressure such that the mean free path of the sample ions for analysis is longer (and preferably much longer) than the length of the deflection trajectory, but shorter (and preferably much shorter) than the length of the drift trajectory.

Preferably, the pump is arranged so that, in use, the highest pressure region of the chamber is no more than 10 times the lowest pressure region of the chamber, and preferably no more than 5 times, and more preferably no more than 2 times. Although some differences in the pressure at different regions of the chamber may occur (for example, due to the shape or configuration of the chamber) these difference are minimal, and the pressure throughout the chamber is within the same order of magnitude. More specifically, the change of pressure over the length of one mean free path of the ion for analysis is much smaller than the magnitude of the average pressure in the chamber, the change in pressure being less than a) 10%, b) 5% or c) 2% of the magnitude of the average pressure. The pressure in the chamber has an absolute pressure gradient of magnitude less than 10-fold across the chamber (in other words, in the drift region compared to the deflection region), and preferably an absolute pressure gradient of magnitude less than 5-fold across the chamber, and more preferably an absolute pressure gradient of magnitude less than 2-fold across the chamber. No sharp step changes in the pressure will be present, with any gradient of pressure change within the chamber being smooth and relatively shallow. Preferably, there is no partition restricting gas flow between the drift region and deflection region.

Preferably, the pump is arranged to pump the drift region and the deflection region simultaneously. The pump may be a single pump or pumping means. This may be beneficial to ensure the pressure is the same throughout the chamber.

The pump may be connected to the chamber via a single pumping aperture in the wall of the chamber, or via multiple interconnected pumping apertures in different areas of the wall of the chamber but which are all connected to the same pump. Pumping may occur through an ion inlet or outlet aperture. Providing multiple interconnected pumping apertures connected to the same pump may allow great homogeneity of the pressure within the chamber, as it reduces any effects caused by the configuration of the chamber with respect to a single pumping aperture.

Preferably, the ion optics are further configured to accelerate the sample ions upon entry to the deflection region. Sample ions may be accelerated prior to, or simultaneously with, changing the direction of the sample ions. Acceleration of the sample ions upon entry to the deflection region increases the energy of the sample ions so as to reduce any spread of energy between ions of similar mobility. This in turn reduces losses of sample ions as they move on the deflection trajectory through the deflection region.

Preferably, the ion optics are configured to accelerate the sample ions to an energy greater than, and preferably much greater than kT, where k is the Boltzmann constant and T is temperature, but below the fragmentation energy of the sample ions. In an example, the sample ions may be accelerated to have an energy more than four times greater than upon entry to the deflection region, or preferably more than five times greater, or more preferably more than ten times greater than upon entry to the deflection region. In some examples, the sample ions may be accelerated to increase the energy of the sample ions by 2 eV to 10 eV, or preferably by 2 eV to 8 eV, or more preferably by 3 eV to 6 eV.

The sample ions may be accelerated by application of an accelerating electric potential of 1 to 8 V, or preferably 2 to 8 V, or 2 to 6 V.

Preferably, the ions change direction by application in the deflection regions of a linearly changing electric field, or a non-linearly changing electric field. In some cases, the applied electric field forms a potential mirror, to reflect incident sample ions.

Preferably, the drift region is defined within the volume of the chamber such that the drift region has a greater extension in a first direction orthogonal to the direction of the drift trajectory than compared to a second direction orthogonal to the direction of the drift trajectory, wherein the first and second direction are orthogonal to each other. The drift region may be defined within the volume of the chamber such that the drift region is a prism with axial symmetry of order 2. The volume within the chamber comprising the drift region may define a rectangular prism (in other words, with rectangular cross-section), or an oval prism (in other words, with oval cross-section). Beneficially, this configuration for the drift chamber allows reduction in the charge density for a given number of sample ions. This in turn may sharpen the peaks representative of separated ions after ion mobility separation. Similarly, preferably, the deflection region has a greater extension in a first direction orthogonal to the deflection trajectory than compared to a second direction, also orthogonal to the deflection trajectory, wherein the first and second directions are orthogonal to each other. In this way, sample ions entering the deflection region from the drift region may remain spread as they pass in and out of the deflection region.

Preferably, in some embodiments, in use the ion optics are arranged to change the direction of the sample ions on a deflection trajectory so as to reflect the sample ions back towards the same drift region. In this configuration, the chamber comprises a single drift region extending between a first and second deflection region. The ion optics at each deflection region are arranged to reflect sample ions, so that sample ions exiting the deflection region are directed back to the drift region in a direction opposite to sample ions received into the deflection region from the same drift region.

Preferably, in some other embodiments, the chamber houses a first and second drift region and wherein the deflection region is arranged to receive sample ions from the first drift region, and the ion optics are configured to change the direction of the sample ions on the deflection trajectory to travel towards the second drift region;

the first and second drift regions arranged within the chamber such that sample ions passing through the second drift region travel in a direction that is substantially parallel but opposite to sample ions passing through the first drift region. In this configuration, the chamber houses a first and a second drift region that are arranged parallel to each other, and extending between a first and a second deflection region. Sample ions passing through a first drift region are received at a first deflection region, where their direction is changed to move towards the second drift region. The sample ions then move through the second drift region towards the second deflection region. In the second deflection region, the direction of the sample ions are changed to move back towards the first drift region. In this way, sample ions can be circulated around the first drift region, first deflection region, second drift region, second deflection region, and back to the first drift region multiple times. This allows the effective length of the drift region to be increased, without significantly increasing the size of the chamber. As such, better ion mobility separation can be achieved.

Preferably, the chamber houses a first, second and third drift region, and respective first, second and third deflection regions, and wherein a given deflection region is arranged to receive sample ions from a respective drift region to travel on a respective deflection trajectory though the given deflection region, and the ion optics are configured to change the direction of the sample ions on the respective deflection trajectory to travel towards the next drift region. In this particular case, the chamber comprises multiple (three or more) drift regions and respective deflection regions. The chamber is arranged such that the drift regions and deflection regions alternate and connect in a circular fashion.

In other words, in the general case a chamber may comprise N drift regions and N deflection regions (where N=2 or more). The chamber may be arranged such that the first drift region is contiguous with the first deflection region, the first deflection region is contiguous with the second drift region, the second drift region is contiguous with the second deflection region, and so on successively until the N−1^{th} deflection region is contiguous with the N^{th} drift region, which is itself contiguous with the N^{th} deflection region. The N^{th} deflection region is arranged to be contiguous with the 1^{st} drift region. In this way, sample ions can circulate through the chamber, and through each drift region and respective deflection region, sometimes multiple times. In this configuration, the pressure throughout the chamber is still substantially homogenous, as discussed above. For instance, the example embodiment described above comprising a first and a second drift region that are arranged parallel to each other, and extending between a first and a second deflection region, is the case of N=2.

Preferably, for each pass through a given drift region, the sample ions undergo a thermalisation phase and a drift phase, and for each pass through a respective deflection region, the sample ions undergo a ballistic deflection phase. During a thermalisation phase, the sample ions lose energy due to collisions with molecules of the drift gas. The thermalisation phase continues until the sample ions reach an energy of around kT. The sample ion then proceeds in a drift phase, in which further separation of the sample ions takes place dependent on their ion mobility. The sample ions then enter the deflection region and begin a ballistic deflection phase. During this phase, the sample ions travel on a deflection trajectory, changing direction to move towards the same or a different drift region. The sample ions move on the deflection trajectory substantially ballistically (in other words, without collision with molecules of the drift gas).

Preferably, the sample ions further undergo an acceleration phase. The acceleration phase may be prior to the deflection phase, or simultaneous with the deflection phase.

Preferably, the chamber further comprises an ion outlet, further arranged to allow ions for analysis to be ejected out of the chamber via the ion outlet. The chamber also comprises an ion inlet, to allow sample ions to be injected into the chamber via the ion inlet. In some cases, the ion inlet and the ion outlet will be the same aperture in the wall of the chamber. The ion inlet and ion outlet may be separate apertures, and may be positioned in the wall of the chamber in the vicinity of each other or placed in different wall or regions of to the chamber.

Preferably, ions ejected out of the chamber via the ion outlet are passed to a mass analyser. In other embodiments, the ejected ions may be passed to another type of analyser.

Preferably, in use, the chamber is filled with a drift gas (otherwise called a buffer gas).

Preferably, electric potential applied at a given deflector region can further act to store a portion of ions of the packet of sample ions received from the respective drift region. In other words, electric potential can be applied to create a potential well in a portion of the chamber, so as to trap or store a portion of the sample ions. These may be ions of lower mobility than the ion for analysis, for instance, but which could be realised for further separation once the ion for analysis has been ejected from the chamber. A further ion for analysis could be stored within the portion of stored ions. In this way, the system is efficient, as different ions within the initial packet of sample ions can be separated and then ejected for analysis.

Preferably, there may be an ion storage device upstream of the chamber, for storing the packet of ions from an ion source prior to introducing them into the chamber. For example, this may be an ion trap, such as a linear ion trap, C-trap or other trapping device, from which sample ions are ejected into the chamber. The upstream ion storage device may also be for storing ions extracted from the drift region after ion mobility separation has taken place.

Preferably, further comprising a mass analyser for mass analysing ions ejected from the chamber. Other types of analyser could be used in conjunction with the ion mobility spectrometer.

Optionally, the mass analyser is an orbital trapping mass analyser, such as an ORBITRAP™ mass analyser from THERMO FISHER SCIENTIFIC™.

In a further aspect there is a method of ion mobility spectrometry comprising:

introducing sample ions into a chamber through an inlet, the sample ions including an ion for analysis and the chamber housing a first and a second deflection region, with a drift region extending therebetween on a first axis in a first direction, and the chamber further comprising an outlet that is spaced apart from the inlet, the inlet and outlet being coincident on a second axis extending in a second direction, the second direction being orthogonal to the first direction;

passing the sample ions on a first drift trajectory through the drift region towards the first deflection region; and

receiving at the first deflection region at least a portion of the sample ions from the drift region and passing the least a portion of the sample ions on a deflection trajectory through the first deflection region whilst changing the direction of at least the ions for analysis to travel back through the drift region on a second drift trajectory towards the second deflection region;

receiving at the second deflection region at least a portion of the sample ions from the drift region and passing the least a portion of the sample ions on a deflection trajectory through the second deflection region whilst changing the direction of at least the ions for analysis to travel back through the drift region on a third drift trajectory towards the first deflection region;

wherein the sample ions separate according to their ion mobility each time they pass through the drift region;

wherein, when it crosses the second axis, each successive drift trajectory is closer to the outlet than the previous drift trajectory such that the ions for analysis coalesce continuously to, or to the close vicinity of, the second axis for ejection though the outlet; and

wherein the chamber is maintained at a pressure of less than atmospheric pressure and is substantially homogeneous throughout the chamber.

The method describes a further mode for separation of ions according to their ion mobility, and can be used as a ion mobility filter. Sample ions may be introduced continuously (or as a continuous stream) into the chamber according to the method, and for each successive pass back and forth through the drift region (during which ions of different mobilities separate), the sample ions are moved (or stepped) on the second axis (which extends in a direction substantially orthogonal to the direction of trajectories of ions through the drift region) so as to be closer to the outlet. Potentials at electrodes in the chamber cause the ions of interest gradually to converge or coalesce towards the second axis (and the outlet), so that only those ions precisely on the second axis after an appropriate number of passes through the drift region are able to exit the chamber. Suitable choice of potentials allows only the selected ion for analysis to meet the criteria for exiting the chamber, with other sample ions being absorbed (for instance, at the deflection regions) or being further reflected and stored for future ion mobility separation and selection.

Ideally, ions of interest for analysis do not reach the deflection regions but instead stay within the drift regions, although passing back and forth on successive drift trajectories of opposite, or near opposite direction. In comparison, ions of higher mobility than the ions for analysis are received at the deflection regions and may be absorbed or deflected away from the drift region (defocused).

Preferably, the chamber is maintained at a pressure of less than 50% atmospheric pressure, less than 25% atmospheric pressure or less than 10% atmospheric pressure. The chamber may be maintained at a pressure of less than 500 mBar, less than 250 mBar, less than 100 mBar, less than 50 mBar or even lower pressure. The pressure is substantially the same throughout the chamber, and approximately equal in the deflection regions and the drift region.

Preferably, after the sample ions travel back through the drift region on a third drift trajectory, the method further comprises passing the sample ions through the drift region on one or more subsequent drift trajectories before the ions for analysis coalesce to, or to the close vicinity of, the second axis. The sample ions may be passed through the drift region multiple times, in order to achieve sufficient separation of the ions of analysis from other ions within the sample ions. On each pass through the drift region, the sample ions further separate according to their ion mobility.

Preferably, the pressure is such that the mean free path of the ion for analysis is greater than the length of the deflection trajectory, and less than the length of the drift trajectory.

Preferably, a highest pressure region in the chamber is no more than 10 times a lowest pressure region of the chamber, and preferably no more than 5 times, and more preferably no more than 2 times. The pressure throughout the chamber is substantially homogenous. However, where small differences in pressure are present due to the chamber geometry, in particular with respect to the pump outlet, the differences in pressure will be very small as a percentage of the absolute pressure. Any changes in pressure throughout the chamber will be smooth and not stepwise.

Preferably, the method further comprises accelerating the sample ions upon entry to the deflection region. The sample ions may be accelerated to an energy greater than, and preferably much greater than, kT, where k is the Boltzmann constant and T is temperature, but to an energy that is below the fragmentation energy of the sample ions.

Preferably, the drift region is defined within the volume of the chamber such that the drift region has a greater extension in the second direction than compared to a third direction orthogonal to both the first and the second direction. Here, the first direction extends on an X-axis, the second direction extends on a Z-axis, and the third direction extends on a Y-axis, where the Y-axis represents the depth of the chamber. The depth of the chamber (in the Y-axis) is small compared to either of the dimensions of the chamber in the X- or Z-axis.

Preferably, the inlet and the outlet are each linear slits, the linear slits extending in the third direction. In other words, the linear slits extend in the direction of the Y-axis.

Preferably, for each pass through a given drift region, the sample ions undergo a thermalisation phase and a drift phase. For each pass through a respective deflection region, the sample ions may undergo a ballistic deflection phase.

Preferably, the method further comprises ejecting the ions for analysis out of the chamber through the outlet. The ions for analysis ejected out of the chamber may be passed to a mass analyser.

In a still further aspect there is an ion mobility spectrometer comprising:

a chamber housing a first deflection region, a second deflection region, and a drift region, the drift region extending between the first and the second deflection region on a first axis in a first direction, the chamber further comprising ion optics to change the direction of ions passing through the first or the second deflection region or the drift region, the chamber further comprising an outlet that is spaced apart from the inlet, the inlet and outlet being coincident on a second axis extending in a second direction, the second direction being orthogonal to the first direction;

a pump, connected to the chamber for pumping the drift region and the first and the second deflection region housed within the chamber;

wherein the drift region is arranged to receive sample ions introduced to the chamber, the sample ions including an ion for analysis, the drift region arranged such that the sample ions pass on a first drift trajectory through the drift region; and

wherein the first deflection region is arranged to receive at least a portion of the sample ions from the drift region and to pass the least a portion of the sample ions on a deflection trajectory through the first deflection region, the ion optics being configured to change the direction of at least the ions for analysis to travel back through the drift region on a second drift trajectory towards the second deflection region;

wherein the second deflection region is arranged to receive at least a portion of the sample ions from the drift region and to pass the least a portion of the sample ions on a deflection trajectory through the second deflection region, the ion optics being configured to change the direction of at least the ions for analysis to travel back through the drift region on a third drift trajectory towards the first deflection region;

wherein the sample ions separate according to their ion mobility each time they pass through the drift region;

wherein the ion optics are further configured to cause each successive drift trajectory to cross the second axis closer to the outlet than the previous drift trajectory, such that the ions for analysis coalesce continuously to, or to the close vicinity of, the second axis for ejection through the outlet; and

wherein in use the chamber is maintained at a pressure of less than atmospheric pressure and the pressure is substantially homogeneous throughout the chamber. Said ion mobility spectrometer is for separation of sample ions according to their ion mobility, to select an ion of particular mobility for analysis. The chamber allows for continuous introduction of sample ions, whilst the configuration of the ion optics causes only the ions of interest (having specific ion mobility or a specific range of ion mobilities) to be passed out of the chamber through the ion outlet.

Preferably, in use, the pump is configured to maintain the chamber at a pressure of less than 50% atmospheric pressure, less than 25% atmospheric pressure or less than 10% atmospheric pressure. The chamber may be maintained at a pressure of less than 500 mBar, less than 250 mBar, less than 100 mBar, or even lower pressure.

Preferably, in use, the pressure is such that the mean free path of the ion for analysis is greater than the length of the deflection trajectory, and less than the length of the drift trajectory.

Preferably, the pump is arranged so that in use a highest pressure region of the chamber is no more than 10 times a lowest pressure region of the chamber, and preferably no more than 5 times, and more preferably no more than 2 times. The pressure throughout the chamber is substantially homogenous, and any small pressure variations may result from the chamber geometry.

Preferably, the pump is arranged to pump the drift region and the first and the second deflection region simultaneously. A single pump may be used to pump the chamber housing the drift region and the first and second deflection regions.

Preferably the ion optics are further configured to accelerate the sample ions upon entry to the deflection region. The ion optics may be configured to accelerate the sample ions to an energy greater than, and preferably much greater than, kT, where k is the Boltzmann constant and T is temperature, but to accelerate the sample ions to an energy below the fragmentation energy of the sample ions.

Preferably, the drift region is defined within the volume of the chamber such that the drift region has a greater extension in the second direction than compared to a third direction orthogonal to both the first and second direction. Here, the first direction may be considered to extend on an X-axis, the second direction on a Z-axis, and the third direction on a Y-axis, wherein the Y-axis represents the depth of the chamber.

Preferably, the inlet and the outlet are each linear slits, the linear slits extending in the third direction (in other words, extending in the Y-axis).

Preferably, the outlet is arranged to allow ions for analysis to be ejected out of the chamber via the outlet. The ions for analysis to be ejected out of the chamber via the outlet may be passed to a mass analyser. The ion mobility spectrometer may further comprise a mass analyser for mass analysis of ions ejected from the chamber. Optionally, the mass analyser may be an orbital trapping mass analyser.

It will be understood that benefits and characteristics described for any features of any of the aspects described above will apply to any common feature of any other aspect.

### BRIEF DESCRIPTION OF THE DRAWINGS

The disclosure will now be put into practice in a number of ways, and preferred embodiments will now be described by way of example only and with reference to the accompanying drawings, in which:

FIG. 1 shows a schematic representation of a prior art drift tube used for ion mobility spectrometry;

FIG. 2 shows a cross-sectional view of a first example of the IMS system in the to XY plane, together with the potential distribution along the X-axis during different phases of IMS spectrometry;

FIG. 3 shows a cross-sectional view of the first and a second example of the IMS system in the XZ plane;

FIG. 4 shows a cross-sectional view of a first example of the IMS system in the YZ plane, together with the potential distribution along the X-axis during different phases of IMS spectrometry;

FIG. 5 shows a phase diagram of ion motion in the described IMS systems;

FIG. 6 shows a cross-sectional view of the second example of the IMS system in the XY plane, together with the potential distribution along the X-axis during different phases of IMS spectrometry;

FIG. 7 shows a cross-sectional view of the deflector ion optics in the second example of the IMS system in the ZX plane, together with a cross-sectional view of the deflector ion optics in the second example of the IMS system in the XY plane;

FIG. 8 shows further examples of an IMS system;

FIG. 9 is a schematic representation of the described IMS systems as part of a HYBRID QUADRUPOLE/ORBITRAP™ mass spectrometer;

FIG. 10 is a schematic representation of the described IMS systems as part of a hybrid quadrupole/Orbitrap/multi-reflection time-of-flight mass spectrometer; and

FIG. 11 is a further schematic representation of the described IMS systems as part of a hybrid quadrupole/Orbitrap/multi-reflection time-of-flight mass spectrometer.

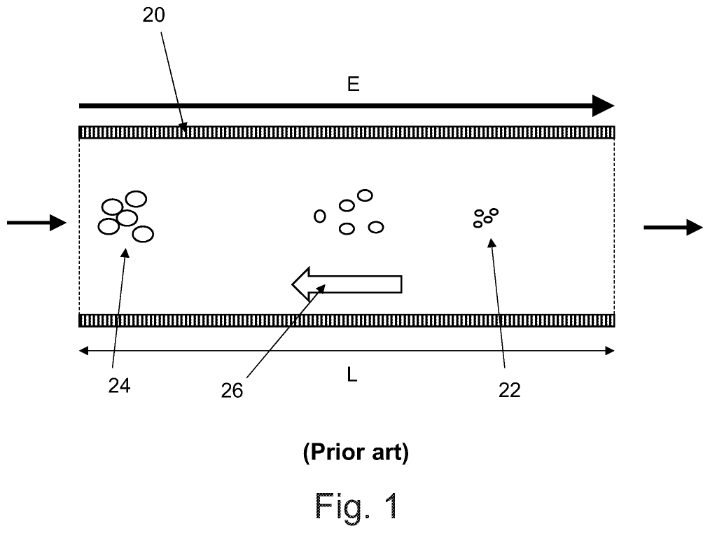

In the drawings, like parts are denoted by like reference numerals. The drawings are not drawn to scale.

### DETAILED DESCRIPTION OF PREFERRED EMBODIMENTS

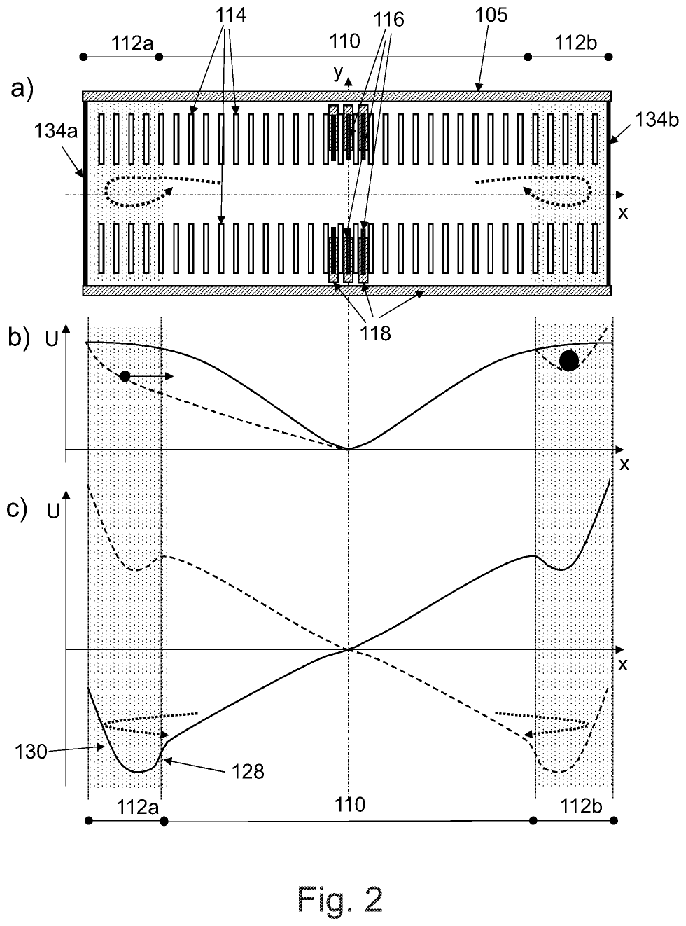

FIG. 2 illustrates a low-resolution system for IMS. The IMS system acts to separate and identify ionised molecules within a packet of sample ions. The packet of sample ions will include at least some ions of interest (in other words, ions to be isolated from others in the packet of sample ions, for identification or further analysis). The packet of sample ions may also include ions that are not of interest, which in some cases will be discarded after separation from the ions of interest. The packet of sample ions may include more than one type of ions of interest which can be separated and the transmitted separately to further analysis stages.

FIG. 2(a) shows a cross-section of the low-resolution system for IMS in the XY plane (wherein the Z plane is into/out of the page). Electrodes are arranged inside and adjacent the walls of a chamber 105 so that a potential can be varied in at least the X-axis of the chamber 105. As explained below, the applied potential gradient creates a drift region 110 in which a typically uniform electric field is present (extending across the centre of the chamber in the X-axis), as well as deflection regions 112a, 112b at each opposing end of the drift region 110, in which non-uniform electric fields are applied to cause a change of direction (or reflection) of sample ions within the chamber. In some cases, although a uniform electric field is the simplest implementation, a non-uniform electric field could be used at least in certain areas of the drift region, for example for spatial focusing of ions as they approach the deflection regions.

In FIG. 2(a), spaced part electrodes having applied radio frequency (RF) alternating voltages and direct current (DC) voltage are shown as white rectangles (and hereafter denoted ‘mixed electrodes’ 114). Electrodes with only DC voltage applied are shown as black rectangles (and hereafter denoted DC only electrodes' 116). Isolators 118 are shown with cross-hatching. The mixed electrodes 114 and DC only electrodes 116 may be provided, for example, as metal plates or as electrodes on a PCB. The mixed electrodes 114 and DC only electrodes 116 are arranged in spaced apart layers opposing on either side of the centre of the chamber along the X-axis.

FIG. 2(b) shows (solid line) the axial potential applied (via the mixed electrodes 114) during ion injection to the chamber along the Z axis, and also shows (dashed line) the potential during ion ejection along the axis Z after ion mobility separation. Ion packets are shown as black circles. The potentials shown are applicable to the injection of positively charged sample ions. It will be understood that the system can be equally applied to negatively charged sample ions by reversing the polarity of the applied potentials.

FIG. 2(c) shows the axial potential applied (via the mixed electrodes 114) during ion mobility separation (solid line for ion movement right to left in drift region, dashed line for ion movement left to right in drift region). Ion trajectories within the potential are shown by dotted lines with arrowheads.

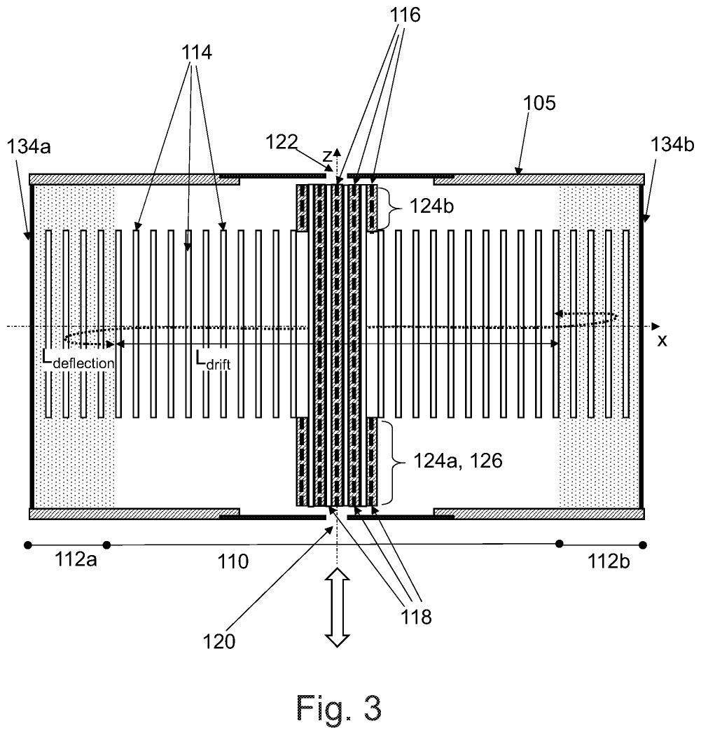

FIG. 3 refers to the same low-resolution system for IMS as shown in FIG. 2. FIG. 3 shows a cross-section of the system in the XZ plane (wherein the Y plane is in to/out of the page). FIG. 3 shows the mixed electrodes 114, the DC only electrodes 116 and the isolators 118 also shown in FIG. 2(a).

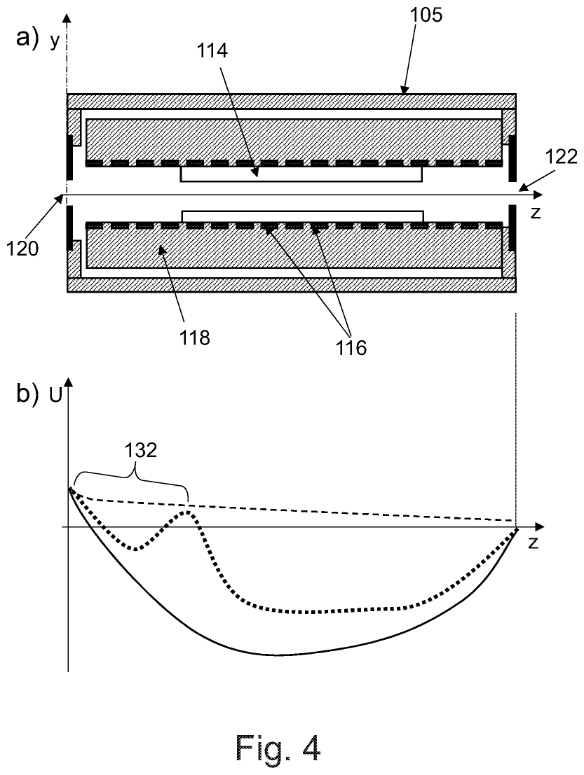

FIG. 4 refers to the same low-resolution system for IMS as shown in FIGS. 2 and 3. FIG. 4(a) shows a cross-section of the system in the YZ plane (wherein the X plane is in to/out of the page). FIG. 4(a) shows the mixed electrodes 114, the DC only electrodes 116 and the isolators 118 also shown in FIG. 2(a) and FIG. 3. FIG. 4(b) shows the axial potential applied during ion injection (solid line), during ion mobility separation (dotted line), and during ion ejection (dashed line) along the axis Z.

Overview of Ion Motion within the IMS System

We will first consider the operation of the low-resolution system for IMS of FIGS. 2 to 4 at a high level, and then provide further discussion of the applied electric fields in each stage of operation.

In use, the chamber 105 contains a buffer gas and will be maintained at a pressure of between 2 and 50 Pa. The chamber 105 is maintained so that the pressure is substantially homogenous across the whole chamber. In particular, the pressure in the drift region and each of the deflection regions is substantially the same (within the same order of magnitude). The chamber may be pumped through a pumping aperture, which may be the ion inlet 120 and/or ion outlet 122 within the wall of the chamber. The whole chamber may be pumped by a single pump or single pumping means. Some minor variation of pressure may be possible when comparing the region of the chamber nearest the pumping aperture and the distant extents of the chamber. However, this variation will be minimal and vary smoothly without any sharp steps or sudden changes in the pressure. The highest pressure region of the chamber will be no more than 10 times the lowest pressure region of the chamber, so that the pressure throughout the chamber varies by no more than an order of magnitude. Significantly, any change of pressure experienced by a sample ion over one mean free path is much smaller (being 10%, 5% or even 1%) of the absolute magnitude of the average pressure within the chamber

In operation, sample ions from an ion source or a previous stage of mass analysis (not shown within FIG. 2(a), 3 or 4(a)) are initially stored in a trapping device (such as a multipole or a curved linear ion trap (C-trap), also not shown within FIG. 2(a), 3 or 4(a)). From the trapping device, the ions are then injected into the chamber 105 via a chamber inlet 120 and ion guide 124a, which may be a voltage-controllable aperture. Ions could be also transmitted directly from the previous stage of mass analysis and fill chamber 105 for a predetermined time. The chamber inlet 120 may be arranged in any portion of the wall of the chamber 105, but in the specific example of FIGS. 2(a), 3 and 4 the sample ions are injected along the Z axis, to enter at the centre of the drift region 110 within the chamber 105.

After injection, the packet of sample ions is passed through the drift region 110 on a drift trajectory by application of an axial electric field. The electric field is generated by a linear potential gradient across the mixed electrodes 114 within the drift region 110 along the x-direction, as shown by the solid line in FIG. 2(c). The field may be 10-500 V/m or more preferably 50-200 V/m for use with a low pressure drift region (for example, 0.01-0.05 mbar). For a higher pressure drift regions (for example, 2-4 mbar), the field may be 1000-4000 V/m. A DC voltage source may apply the gradient of voltages across the mixed electrodes 114, for example by means of a resistive divider. In the example of FIGS. 3 and 4(a), the drift trajectory of the ions is substantially aligned along the X axis.

Upon reaching an end of the drift region 110, the sample ions of interest enter a first deflection region 112a. Within the first deflection region 112a, a non-linear electric potential is applied by the adjacent mixed electrodes 114 which creates a potential barrier and causes the sample ions to change direction, thereby moving off the drift trajectory and on to a deflection trajectory. In the example of FIGS. 3 to 4(a), the deflection trajectory is a reflection of the sample ions, back towards the drift region 110 through which the sample ions have just passed.

Whilst the ions of interest pass through the deflection region, the electric field generated by voltage applied at mixed electrodes 114 in the drift region will be modified to reverse the gradient of the linear potential in the drift region 110, with a corresponding shift in the offset voltage relatively to ground of all electrodes involved (as shown by the dashed line in FIG. 2(c)). Applied voltages on the mixed electrodes 114 may be changed within 3-10 microseconds. Preferably, this reversal in the electric field takes place without disturbing the motion of the sample ions in a given deflection region 112a. The reversed electric field offers a reduced potential barrier for re-entry to the drift region.

After passing out of the deflection region 112a, the sample ions may then pass back through the drift region 110, along a drift trajectory aligned with the X axis, but in an opposite direction to the earlier drift trajectory.

In the example of FIGS. 3 to 4(a), two deflection regions 112a, 112b are arranged within the chamber. The deflection regions are arranged at opposite sides of the chamber 105, and at opposite ends of the drift region 110. Therefore, the drift region 110 is configured to extend between the two deflection regions 112a, 112b in the chamber 105. After deflection from the first drift trajectory, as described above, the sample ions of interest pass back through the drift region 110 on a second drift trajectory toward the second deflection region 112b (as a result of application of the reversed electric field). Upon reaching the second deflection region 112b, a non-linear electric potential is applied causing the sample ions to change direction, moving away from the second drift trajectory and on to a second deflection trajectory. In the example shown, the sample ions are reflected in the second deflection region 112b, back towards the drift region 110.

Once the ions have re-entered the drift region 110, the sample ions may move on a third drift trajectory back through the drift region 110, back towards the first deflection region 112a. Repeating this motion, the sample ions may move back and forth though the drift region 110, and on each pass the ions may be further separated according to their mobility. Eventually, the separated ions will be ejected from the chamber for further analysis (see further discussion below).

For each pass of the drift region, after initial entry to the drift region 110, the sample ions first dissipate their residual energy in collisions with the buffer gas and then become further separated according to the ion mobility. For each pass through the drift region 110, only ions of interest are provided with ideal conditions for ion mobility separation. RF voltages on mixed electrodes 114 and DC voltage on electrodes 116 provide focusing for ions venturing away from the centre of the drift region.

FIG. 3 shows portions 124a, 124b of the DC only electrodes 116 that extend in the Z-axis beyond the mixed electrodes 114. These portions 124a, 124b may provide optional conductivity restrictions near to an inlet or outlet to the chamber 105. Furthermore, they may provide an optional region 126 for ion storage (in particular, storage of ions separated via the ion mobility separation process in the drift chamber).

### Requirements for the IMS System

In order to ensure that ions are separated according to their mobility whilst travelling on the drift trajectory, the ions must undergo collisions with a buffer gas within the drift region. Accordingly, the mean free path of the sample ions (and more especially, the sample ions of interest), mfpᵢₒₙ, must be less, and ideally much less, than the length of the drift trajectory, L_{drift}, between deflection regions. The mean free path length of ions corresponds to the distance over which the ions of cross-section a lose momentum by a multiple of e=2.718281828, i.e.:

$$m f {p}_{i o n} = \frac{( M + m )}{m} \cdot \frac{1}{n \sqrt{( {σ}^{2} + {σ}_{ℊ}^{2} )}}$$

where m is mass of gas molecule, M is the mass of the ion, n is the number density (concentration) of the gas and σ_{g} is the cross-section of a buffer gas molecule.

However, separation of ions according to their mobility should be avoided in the deflection region. Instead, the motion of the ions through the deflection region should be ballistic (in other words, without collisions with other particles, and more particularly without collisions with particles of the buffer gas). For this reason, the mean free path of the to sample ions (and more especially, the ions of interest), mfpᵢₒₙ, should be greater than, and preferably much greater than, the length of the deflection trajectory, L_{deflection}. A negligible loss of ions (less than 0.1%) at every deflection is desired, and so ideally, mfpᵢₒₙ, should be greater than the length of the deflection trajectory, L_{deflection} by a factor of at least three times, such as 3 to 30 times, or more preferably at least five times, such as 5 to 20 times. This assumes that loss would result from two or more collisions per traverse through a deflection region.

Accordingly L_{drift}>mfpᵢₒₙ>L_{deflection}, and more preferably L_{drift}>mfpᵢₒₙ>>L_{deflection}. The inventors of the present invention have recognised that these constraints can be met by appropriate selection of pressure across the chamber. Most importantly, these constraints can be met even with a pressure that is the same (or substantially the same) in both the deflection and drift regions. In particular, this constraint requires appropriate selection of the pressure in view of the ratio of the length of the drift trajectory, L_{drift}, to the length of the deflection trajectory, L_{deflection}. In general, the length of the drift trajectory, L_{drift}, must be much longer than the length of the deflection trajectory, L_{deflection} preferably at least a) 5, b) 10, or c) 20 times longer, although some limitations will be imposed by the size of the instrument and the configuration of the ion optics within it.

In the drift region, the velocity of ions in the drift region, v=E×K is directly related to the applied electric field. On the contrary, in the deflection region in which ion motion is ballistic, the ion motion is described by the differential Lorenz equation:

$$\frac{d ν}{d t} = ( \frac{e z}{m} ) E$$

This relates the electric field to the ion's acceleration rather than the velocity. In the ballistic mode the ion motion may be reversed in a static electric field, like the one used in reflectron-type mass-analysers.

Recognition that the pressure in the deflection regions and the drift regions can be equal (or substantially equal) has been shown to provide a number of benefits. In particular, this allows greater flexibility in the design and shape of the chamber. Most significantly, when compared to the prior art IMS system described in Patent Publication No. US 2016/084799 the deflection regions do not need to be pumped to a much lower pressure than the drift region. As such, the chamber may define a volume for the drift region that is elongate in both the direction of the drift trajectory and a direction perpendicular to the drift trajectory (so that the drift region is a rectangular prism, or a prism with axial symmetry of order 2), rather than axially symmetrical to infinite order. Consequently, sample ions may spread perpendicularly to the direction of mobility separation (in other words, in the Z axis of FIG. 3, whilst the drift trajectory is in the X-axis). This shape for the chamber, in turn, brings advantages. In particular, use of a chamber defining a drift region that extends further in both the X- and Z-direction compared to the Y-direction:
1. Increases the space charge capacity of the drift region by one to two orders of magnitude compared to an axially symmetrical drift space. This is important because the maximal current density of ions that can be transmitted through the drift space is limited by the space charge density, as a result of the repulsion between the ions which leads to beam spreading. Significant broadening can be seen once the ion number density in a drift space becomes comparable to a space charge saturation limit. Therefore, increasing the space charge capacity of the drift space, as permitted within the presently described system, allows the number of ions in the packet of sample ions to be increased and/or reduces broadening in the separate ion peaks for the same number of sample ions. The larger the volume over which sample ions can be distributed, the greater the reduction in charge density.
Furthermore, recognising that the pressure in the deflection regions and the drift regions can be equal or substantially equal:
2. Allows the chamber to be pumped only at a single aperture, or at just the entrance (and, if separate, exit) aperture(s) to the chamber. This increases the flexibility and reduces the complexity of the arrangement of the IMS system within a wider instrument (for instance, in conjunction with low-pressure stages of mass spectrometry). Said apertures can have only a small diameter.
3. Allows the chamber to be homogenous without necessarily providing partitions or restrictions within the chamber (for example, between a drift region and a deflection region), as would be required for prior art arrangements where the deflection regions are pumped to a lower pressure than the drift region.

After passing through the drift region 110, sample ions will be thermalized. This means that their energy is comparable to kT, where k is the Boltzmann constant and T is temperature (such that with a weak applied electric field E along the drift tube, (E×mfpᵢₒₙ)<kT). However, amongst a portion of sample ions having a similar mobility, there will still be some distribution of energies as soon as they are extracted into the deflection region. To change the direction of the ions in the deflection region without losses, one option is to spatially focus the ions within the portion of ions of similar mobility so as to reduce the spread (or standard deviation) of the distribution of energies. To reduce the relative energy spread of the extracted ions, the ions can be accelerated. By accelerating the portion of the sample ions, although absolute energy spread will increase, the relative spread of energies (compared to the overall magnitude of the ion energy) is reduced.

Although acceleration is not a requirement for the successful operation of the described IMS system, in practice it provides a method to overcome the requirement to introduce other constraints within the system. In a regime where ions are accelerated upon leaving the drift region and entering the deflection region, the ions should be accelerated to an energy above, and preferably substantially above, the thermal energy kT. For example, the ions should be accelerated to an energy more than two times kT, more than three times kT, more than four times kT, more than five times kT, more than ten times kT, more than forty times kT, or more than one hundred times kT. In an example, acceleration of the sample ions may result in an increase of energy of the sample ions by between 1 eV and 12 eV, by between 2 eV and 8 eV, or more preferably by between 3 eV and 6 eV. However, the accelerated ions should be kept at an energy below their fragmentation energy. In some examples, the fragmentation energy will be around 8-10 eV.

In the example of FIGS. 2(a) to 4, the ions are accelerated by a local, strong electric field (by application of an electric potential up to 5-10 V) upon immediate entry to the deflection region, in order to accelerate sample ions ahead of the buffer gas. The acceleration of the sample ions marks the start of the deflection region, in which the ions undergo ballistic motion. After leaving the deflection region, the ions enter the drift region preferably before they lose a significant part of this energy, preferably when energy loss is less than a) 70%, b) 50%, c) 30%, d) 20%. In addition, the deflection, especially reflection, focuses the ions in space (preferably, a parallel beam is focused to a point) with minimum time of flight aberrations.

Immediately before leaving the deflection region (and prior to entry into a drift region) the sample ions may be deaccelerated. This ensures that the sample ions will reach thermalization within the drift region, and undergo separation according to ion mobility. Further discussion of the ion optics required to perform acceleration, change of direction and deacceleration of the ions is provided below.

### Potential Applied at Electrodes of IMS System

FIGS. 2(b) and 2(c) show the electric potential applied across the X-axis during each pass of ions through the drift region 110 and the deflection regions 112a, 112b. The potential is applied to the ‘mixed electrodes’ 114 of the IMS system (i.e. the electrodes with both RF and DC voltages). The electric field within the drift region 110 and deflection regions 112b is the derivative of the electric potential.

More specifically, FIG. 2(b) shows the electric potential applied across electrodes 114 when ions are first injected into the chamber 105 along the Z-axis (from the inlet 120, as shown in FIG. 3). Looking to the potential applied in the X-axis during ion injection (FIG. 2(b)) it can be seen that a potential well in the centre of the chamber is used to capture and pool the ions about the Z-axis.

In contrast, FIG. 2(c) shows the electric potential applied across electrodes 114 when the ions are passing through the drift region 110 and the deflection regions 112a, 112b. It can be seen that a linear potential is applied across the electrodes 114 in the drift region 110, thereby causing the ions to move through the drift region 110. Upon entry to the first deflection region 112a, the potential is lowered 128 to cause acceleration of the ions, and then increased 130 to cause the ions to change direction back towards the drift region 110 (e.g., to be reflected). In other words, the application of electric potential in this configuration of the IMS system acts as an ion mirror.

As noted above, in this example, ions enter the chamber 105 along the direction of the Z-axis. FIG. 4(b) shows the electric potential applied to electrodes 116, which may be PCB electrodes, to create an electric field that varies in the Z-direction. The electric potential is applied by a time dependent DC voltage on the DC only electrodes 116. The potential represented by a solid line in FIG. 4(b) shows the potential applied during ion injection. In particular, a potential well is formed to cause the sample ions entering the chamber 105 to move to the centre of the chamber in the Z-direction. Once in this position, the ions will be exposed to the electric field applied by mixed electrodes 114 described above with respect to FIG. 2(c) and causing movement through the drift region 110 in the direction of the X-axis.

The dotted line in FIG. 4(b) shows the electric potential applied to electrodes 116 during ion mobility separation (when ions are passed back and forth in the X-direction through the drift region 110). Here it can be seen that most ions are encouraged to pool within the chamber 105 in the vicinity of the mixed electrodes 114. However, some ions (such as sample ions that have been separated but that are not of present interest) can be captured and stored by creation of a potential well 132 near to the chamber inlet 120 (in region 126 of FIG. 3).

The dashed line in FIG. 4(b) shows the electric potential applied to electrodes 116 during ion ejection. Here, a potential gradient is formed causing ions to move towards an exit aperture 122, positioned in the wall of the chamber 105 opposite the entrance aperture 120.

Due to the folding of ion trajectories (by passing back and forth through the drift region 110), faster ions with higher mobility and slower ions with lower mobility need to be treated differently. In particular, higher-mobility ions will pass ahead of ions of interest and so arrive earlier to a given deflection region 112a. There will then be several ways of dealing with these higher-mobility ions:
1. Storing mode: allow the higher-mobility ions to lose energy before the ion of interest arrives at the given deflection region 112a, so that the higher mobility ions become stored at the bottom of a potential well in the deflection region 112a. In this case, the higher-mobility ions, which are not themselves of interest, may be periodically transmitted towards the other, opposing deflector region 112b with some delay after the ions of interest pass out of the first deflector region 112a, so as to get stored in the opposite deflection region 112b and not interfere with a final stage of separation. Stable storage is usually implemented by a combination of static and RF voltages on electrodes 114.
2. Discarding mode: discard the higher-mobility ions that are not of interest to DC electrodes (134a, 134b in FIG. 2(a)) arranged at the far ends of the deflector region, by application of correctly timed DC voltage on these electrodes. This mode could be applied in both deflection regions 112a, 112b, or at only one of them.
3. In both modes, ions with lower mobility than the ions of interest can stay within the drift region 110, passing back and forth in the drift region without reaching or entering the deflector regions 112a, 112b.

After the final stage of ion mobility separation, the ions of interest arrive in one of the deflection regions 112a and voltages are applied so that the ions are captured and stored there. Meanwhile, an electric field is applied across the drift region 110 to provide an electric potential gradient that causes ions with lower mobility than the ions of interest to move towards the other deflection region 112b, where they may be stored. Subsequently, a minimum of electric potential is generated in the centre of the drift region 110 along the Z-axis, similar to operation during injection. Voltages in the first deflection region can then be changed to release the ions of interest, so that they move towards the potential minimum at the centre of the drift region. From there, the ions of interest can be ejected from the chamber by creating a potential gradient along the Z-axis (as shown in FIG. 4(b). If required, the ion mobility separation process continues to select further ions of interest from remaining (lower-mobility) ions that were stored in the other deflection region 112b. As such, the described system allows for use of the one initial packet of sample ions to select different ions of interest having different mobilities. Thus, the system advantageously gains sensitivity by better sample utilization of the initial packet of sample ions.

Phase Diagram of Ion Motion within the IMS System

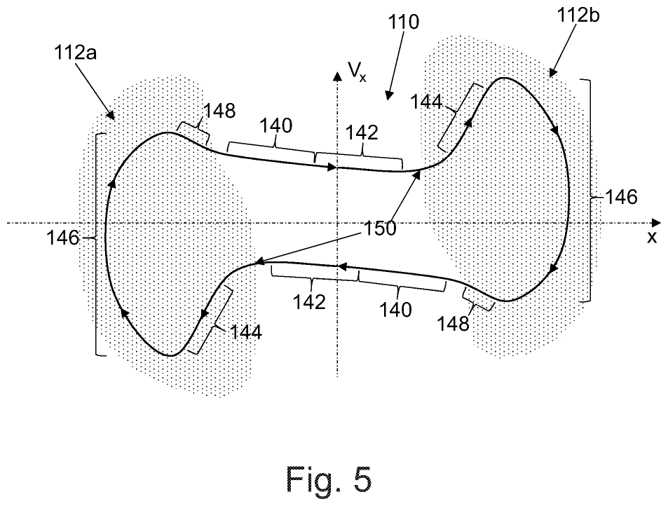

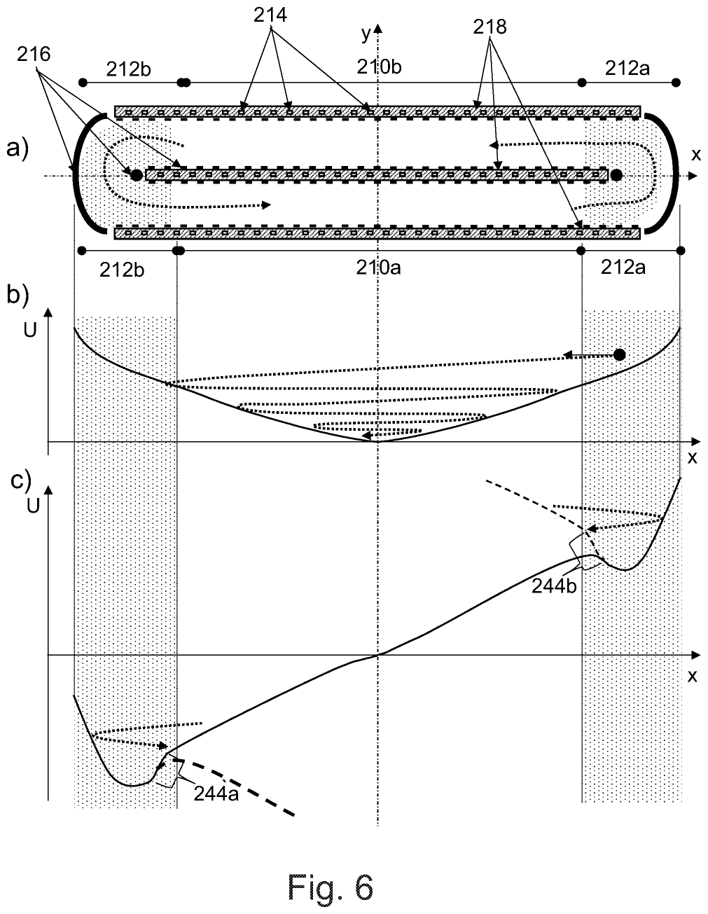

FIG. 5 shows a phase diagram of ion motion within the IMS system of FIGS. 2, 3 and 4. The phase diagram shows the velocity of sample ions in the X-direction, Vₓ, versus the position, x, on the X-direction. The same phase diagram would apply to the example of the IMS system described with reference to FIG. 6, below.

In FIG. 5, it can be seen that the motion of the ions is cyclical, being cycled through the drift region 110 and the deflection regions 112a, 112b until the required level of ion mobility separation is achieved. For each pass through the drift region 110, the ions move from one deflection region 112a to the other deflection region 112b upon application of a (typically, uniform) electric field. As the ions progress through the drift region they undergo a thermalization phase 140 and separate according to their mobilities during a drift phase 142.

Upon entry 150 to the deflection region 112b, the ions go through an acceleration phase 144 by movement through a potential gradient, thereby increasing their energy. A non-linear potential gradient is applied to change the direction of the ions during a ballistic phase 146 so as to be redirected back towards the drift region 110. Some deceleration 148 of the ions is caused (by application of a further potential gradient, opposite in direction to that at the start of the deflection region) prior to leaving the deflection regions 112a, 112b and before re-entry or capture into the drift region 110.

Ions may undergo multiple passes through the drift region, each time undergoing the described phase cycle.

### The High-Resolution IMS System

FIG. 6 shows another example of an IMS system. This IMS system may provide a higher resolution of mobility separation of sample ions than the system described above with respect to FIGS. 2 to 4. Although the essential concepts behind the IMS system of FIG. 6 are the same as the system of FIGS. 2 to 4, there are also some differences. In particular, the system of FIG. 6 provides repeated cycling of sample ions through a first then a second drift space, rather than back and forth in the same drift space (as in the system of FIGS. 2 to 4).

In the low-resolution system of FIGS. 2 to 4, longitudinal broadening of a peak following mobility separation remains smaller than the reflection region. However, in a high-resolution system total path length becomes so high that broadening of a peak following mobility separation is to a greater length than the reflection region. Importantly, the ion motion undergoes the same phases (as shown in FIG. 5) in the high-resolution IMS system of FIG. 6 as in the low resolution system of FIGS. 2 to 4—the only difference being that the thermalization and drift phases of motion will take place in the same drift region in the low resolution system of FIGS. 2 to 4, but will take place in different drift regions in the high-resolution system of FIG. 6.

FIG. 6(a) shows a cross-section of the high-resolution system for IMS in the XY plane (wherein the Z plane is in to/out of the page). In FIG. 6(a), electrodes having applied radio frequency (RF) alternating voltages and constant (DC) voltage are shown as white, unfilled portions (hereafter denoted ‘mixed electrodes’ 214), electrodes with only DC voltage applied are shown as black-filled portions (and hereafter denoted DC only electrodes' 216). Isolators 218 are shown with cross-hatching.

A first 210a and second 210b drift region are defined, separated by an isolator 218 and electrodes 214, 216. In this example, the first 210a and second 210b drift regions are each shaped as a rectangular prism (elongate in both the X- and Z-axis, but with its smallest dimension in the Y-axis), and arranged to be parallel and adjacent to each other. The first 210a and second 210b drift regions are connected via a first 212a and a second 212b deflection region arranged at each end of the drift regions 210a, 210b. In other words, the drift regions 210a, 210b are parallel and extend between the two deflection regions 212a, 212b.

FIG. 6(b) shows the axial potential applied (via the mixed electrodes 214) during ion injection prior to ion mobility separation (solid line) and/or ion ejection after ion mobility separation. The ion trajectory within the potential well for the latter case is shown as a dotted line. FIG. 6(c) shows the axial potential applied (via the mixed electrodes 214) during ion mobility separation (solid line shows potential for ion movement through drift region right to left, dashed line shows how potential distribution looks like on the other side of the deflection regions). Again the ion trajectories are shown by dotted lines.

In use, ions are injected into the first drift chamber 210a. A DC potential (see FIG. 6(b)) is applied to create a minimum, causing the ions to pool in the centre of the first drift region 210a. Once collected in this way, the potential can be changed to cause ions within the drift chamber to move towards the first deflection region 212a (see FIG. 6(c)). A non-linear potential is applied in the deflection region 212a so as to change the direction of the ions 180° so as to be moved back towards the second drift region 210b. In the example of FIG. 6(c) it can be seen that an accelerating potential 244a is also applied upon entry to the first deflection region 212a.

Subsequent to passing through the first deflection region 212a, the ions move through the second drift region 210b on a drift trajectory. The ions then enter the second deflection region 212b. While ions move, DC offset on all electrodes is raised relatively to ground. After leaving the second drift region 210b and entering the second deflection region 212b, ions are initially accelerated 244b, before a deflection field is applied to change the direction of the ions. The second deflection region 212b changes the direction of the ions until they are directed back towards the first drift region 210a. From here, the ions can move on a further drift trajectory through the first drift region 210a, and the cycling of the sample ions through the first and the second drift regions 210a, 210b (via the first and second deflection regions 212a, 212b) can be repeated. In this way, the sample ions can be cycled around the first and the second drift regions 210a, 210b, until a suitable level of ion mobility separation is achieved.

In the high-resolution system for IMS of FIG. 6, ions continuously cycle in the same direction (for instance, clockwise in FIG. 6). The DC potential difference across both drift regions 210a, 210b may be the same, but the magnitude of the potential can be offset between the two drift regions 210a, 210b in synchronization with the motion of the ions of interest. For example, when ions of interest are fully inside the upper drift region 210b, the potential in this drift region can be raised compared to the potential at the first drift region 210a so that the first drift region is ready to accept the ions of interest, and to can be set to conditions optimum for reflection in deflection region 212a. As a result, ions are reflected and guided to turn by 180° at the deflection region 212a, preferably then being focused onto the central axis of the other drift region 212a. Furthermore, by careful timing of the voltages in the deflection regions, the deflection voltage can be set to attract and discard certain ions that are not of interest (both of higher and lower mobility, as in this embodiment both lower and higher mobility ions will pass through the deflector regions as the sample ions are cycled).

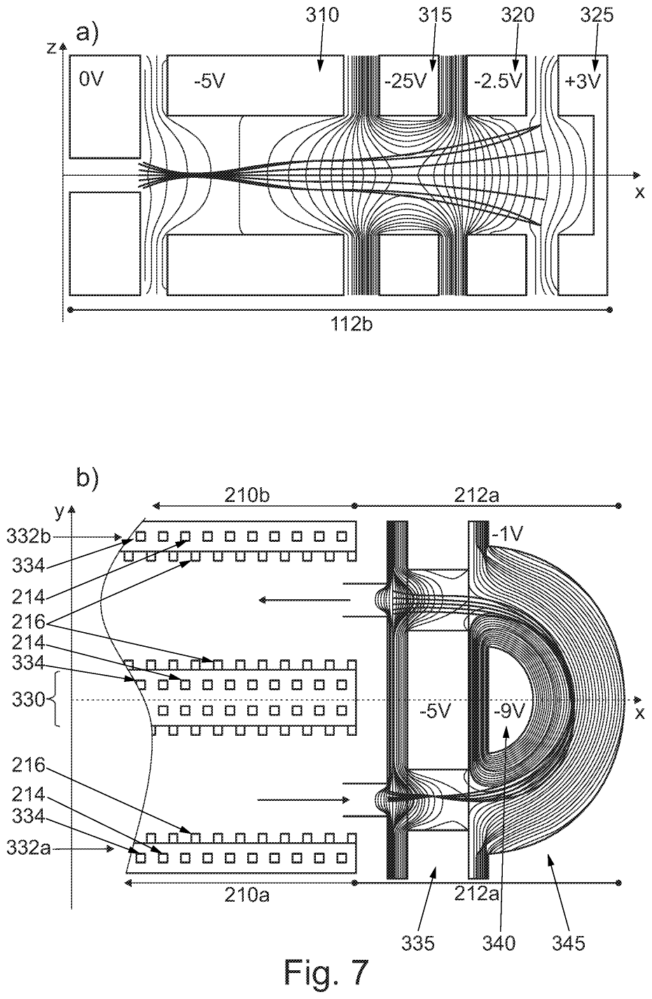

The details of the ion optics in the deflection regions 212a, 212b are discussed further below, with respect to FIG. 7.

### Ion Optics for Deflector Regions of the High-Resolution IMS System

FIG. 7 shows further details of the ion optics used in the deflector regions of the IMS systems shown in FIGS. 2 and 6. In particular, FIG. 7(a) illustrates a cross-section of the ion optics in the deflector (or reflector) region in the XZ plane of the IMS system of FIG. 2, and FIG. 7(b) illustrates a cross-section of the ion optics in the deflector region in the XY plane of the high-resolution IMS system of FIG. 6. The applied voltages are shown with respect to the end of the drift regions 110 and 210a, 210b, respectively.

Considering FIG. 7(a) and the IMS system of FIG. 2, upon entry to the deflection region 112b from the first drift region 110 (FIG. 2) ions are accelerated by application of a bias to a first electrode 310 (in the example of FIG. 7(a), the ions are accelerated to −5 eV per elementary charge with application of a voltage of 5 V to the first electrode). A second electrode 315 then serves as a focusing lens (in the example shown, a bias of −25 V is applied to this second electrode). A third 320 and fourth 325 electrode (in this example biased to −2.5V and +3V respectively), generate an ion mirror to send the ions back towards the drift region 110. The ions are further decelerated prior to entry of the ions into the drift region 110. As such, when passing through the deflection region 112b from the drift region 110, ions are guided along the first deflection trajectory, whilst being accelerated to a kinetic energy of 5 eV, reflected 180° by the mirror sector, and then decelerated before re-entering the drift region 110.

In the ion optics of the deflector region of the high resolution IMS system of FIG. 6 (as shown in FIG. 7(b)), ions received into the deflection region 212a from the first (lower) drift region 210a, accelerated to a kinetic energy 5 eV with the application of a voltage of 5 V to a first electrode 335, deflected by a cylindrical sector (comprising an inner electrode 340 at −9V and outer electrode 345 at −1V), and decelerated before entering the second (upper) drift region 210b.

To minimize ion path length when ions move through the 180° turn of the deflection region in the IMS system of FIG. 6, a new design of RF and DC electrodes is shown in FIG. 7(b). The novel configuration of electrodes adjacent the drift regions allows for a small radius of turn in the deflection region. In particular, the configuration of electrodes allows minimisation of the spacing between the parallel first 210a and second 210b drift regions.

Referring to FIG. 7(b) it can be seen that DC voltage DC only electrodes' 216 are located on the surface of an isolating panel 334 (such as a printed circuit board, PCB). Said DC electrodes 216 may be arranged as surface mounted components on the panel or as a surface layer of a PCB board. These DC voltage electrodes 216 have no RF voltage applied.

Meanwhile, separate RF voltage electrodes 214 are embedded in the isolating panel (or PCB) 334. Said RF electrodes may be embedded in the isolating panel, and in to some cases may be arranged as a second layer in the PCB board compared to the surface layer comprising the ‘DC only’ electrodes 216. The middle panel could be provided as two separate PCB, each with surface DC electrodes 216 and embedded RF voltage electrodes 214, or as a single PCB with two embedded layers of RF voltage electrodes 214 and DC electrodes 216 on each opposing surface.

In the example of FIG. 7(b), the RF voltage electrodes 214 in the partition 330 between the first and second drift region of the chamber are arranged in an isolating panel 334 between DC electrodes 216 on each opposing planar surface of the isolating panel. For the outer walls 332a, 332b of the chamber, the RF electrodes 214 are arranged embedded within an isolating panel 334 with DC electrodes 216 on only the upper or the lower surface of the isolating panel 334. As such, the configuration of FIG. 7(b) shows a central part or partition 330 of the chamber being implemented as an isolating panel or PCB with four layers: an upper layer defining electrodes 216 applying DC voltages in the upper, second drift region 210b; a first middle layer defining a first layer of electrodes 214 applying RF voltage in the drift region 210b; a second middle layer defining a second layer of electrodes 214 applying RF voltage in the drift region 210a; and, a lower layer defining electrode 216 applying DC voltages in the lower, first drift region 210a. In an alternative, there may be only a single middle layer, defining one layer of electrodes 214, configured to apply RF voltage in both the first and the second drift regions 210a, 210b, wherein appropriate timing of RF voltage provides control of ions in either the first drift region 210a or the second drift region 210b.

RF voltages of alternating phases can be applied to the RF electrodes 214. As the gradient of the DC voltage applied across the DC only electrodes 216 is much smaller than the RF voltage applied across the RF electrodes 214, an offset can be applied on the RF electrodes whilst independently varying the offsets between the drift regions 210a, 210b across a wide range (for example, between −50 to 50 V).

It is noted that in certain specific examples, a buffer gas could be supplied in to the drift region of a chamber housing the ion optics described with reference to FIG. 7, whilst pumping (or additional pumping) is also connected to deflection regions. Due to the restriction along the length of the drift region, this would allow a gradual increase of the mean free path length while approaching the deflection regions up to a factor 2-3 times greater than when compared to the mean free path length in the corresponding drift region. However, the additional pumping of the deflection regions in this way is not an essential requirement for operation of the described IMS system. Moreover, unlike prior art US2016084799, there is no clear separation between stages of drift and inertial motion but rather a gradual transition over lengths that exceed the mean free path for the sample ions.

Significantly, in all described examples of the present invention the pressure at the highest pressure region of the chamber is no more than 10 times the lowest pressure region of the chamber, and preferably no more than 5 times, and more preferably no more than 2 times. Thus, the overall pressure gradient in the chamber (across both drift and deflection regions) should not be more than 5-fold or 10-fold.

### Further Configurations of the IMS System

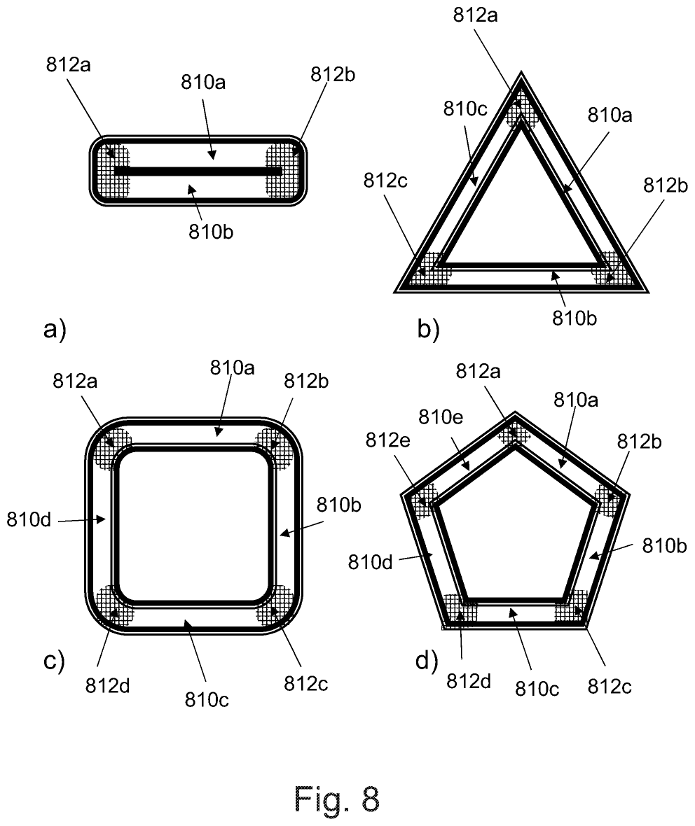

Further configurations for the high-resolution IMS system can be envisaged. In particular, three, four or more drift regions 810a, 810b, 810c, 810d, 810e can be arranged consecutively, in a cyclical manner, with a corresponding deflection region 812a, 812b, 812c, 812d, 812e therebetween as shown in FIG. 8 (wherein the cross-hatched regions represent the deflection regions, and the white regions represent the drift regions).

The two-drift stage system shown in FIG. 8(a) is the same as the high-resolution system described above in relation to FIG. 6. In the two-stage system, during the ion mobility separation phase ions are allowed to spread over the course of the drift region up to the length of a single drift stage. This corresponds to almost 50% of the entire circumference of the device (i.e. duty cycle is 50%). To allow longer separations and even wider spread, more stages of IMS could be envisaged: starting from a 2-stage device in FIG. 6 and FIG. 8(a), to a 3-stage device in FIG. 8(b) (duty cycle 66%), to a 4-stage device in FIG. 8(c) (duty cycle 75%) or a 5-stage device in FIG. 8(d) (80% duty cycle). In fact, an n-stage system (having n drift regions, each with a corresponding deflection region) can be envisaged with

$$Duty Cycle = ( 1 - \frac{1}{n} ) \times 100 \%$$

In these devices, multiple of the drift stages could be used simultaneously to allow separation of different ions within the packet of sample ions in different drift regions.

For ballistic operation in the deflections regions in all embodiments, pressure is preferably sustained in the range 0.01-0.1 mbar (i.e. 1-10 Pa), and the axial field is preferably around 50-200 Vm⁻¹ (corresponding to 100-300 Townsend), consequently, axial ion velocity lies in the range 50-300 ms⁻¹. This ion velocity is above (and generally substantially above) the low-field conditions typical for conventional ion mobility spectrometry. Instead the conditions correspond to those under so-called asymmetric waveform ion mobility spectrometry. Accordingly, ion interaction with the buffer gas (typically nitrogen) is no longer defined by the Langevin model, but instead more by a hard sphere model. In reality, mobility starts to depend not only on ion cross-section but also on molecular structure (because of heating by the strong electric field). While this effect could be corrected to some degree by calibration, it is likely to depart from conventional ion mobility separation proportional to collisional ion cross-section. Application of strong axial field means that mobility becomes less correlated with m/z, and therefore less resolution is usually needed for separation of certain ions, e.g. isomers.

A single pass of an ion under the conditions outlined for the described examples is quite fast, in the range of 100-1000 μs. Therefore, all voltage switching in the described examples operates at least at kHz frequencies, with microsecond rise times. Fortunately, the switched voltages have a relatively small magnitude (within 5-20 V). Axial gradients require higher voltages, up to 100 V, but also could have millisecond rise times. At the same time RF voltages could reach 1000 V peak-to-peak, though strong electric fields are localized in the periphery of the system and are negligible on the plane of symmetry.

Furthermore, in all of the described examples it is important that pressure stays below the threshold for breakdown of the ions at RF frequencies (for instance, see e.g. Yangyang Fu et al., “Electrical breakdown from macro to micro/nano scales: a tutorial and a review of the state of the art”, Plasma Res. Express 2 (2020) 013001). The characteristic parameter for breakdown is P×H<0.2 torr cm, where H is the gap between opposing RF electrodes.

In the described examples, ions separate according to ion mobility with a resolution, R₁, of about 5 to 10 at each pass through the drift region, and wherein the total resolution, ΣR, increases as a square root of the number of passes through a drift region. For this resolution to be achieved, it is important that peak broadening due to time-of-flight aberrations remain much less that ion mobility separation diffusion broadening, ΔIM, i.e.:

$${Δ}_{T O F} ≪ {Δ}_{IM} where {Δ}_{IM} = L \sqrt{\frac{k T}{e z U}} = \frac{L}{2 {R}_{1}}$$

where U is the potential drop along a drift region, preferably in the range 5 to 20 V. However, this condition applies only to aberrations that add stochastically. For linearly growing broadening (e.g. due to space charge in the peak), the total of these aberrations will stay significantly below

$$\frac{L}{Σ R} .$$

Implementation of the Described IMS Systems with Mass Analysers

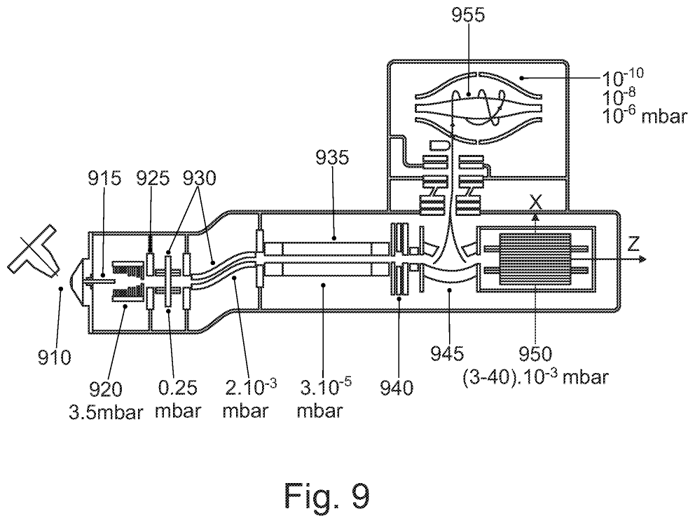

FIG. 9 shows an example of the incorporation of a described IMS system as a part of a hybrid quadrupole/Orbitrap mass spectrometer. Any of the described embodiments of the high resolution system could be used. In particular, FIG. 9 shows: to an electrospray ion source 910, a high capacity transfer tube 915, an electrodynamic ion funnel 920, an internal calibrant source 925, an advanced active beam guide 930, a quadrupole mass filter 935, a charge detector 940, an ion trap 945 (here a C-trap), the described IMS system 950 (specifically, an ion routing multipole combined with the described ion mobility separation chamber), and a mass analyser 955 (here an ultra-high field Oribtrap mass analyser). Typical pressures and orientation of the IMS system are indicated in the figure.

In use, a sample is ionised at the electrospray ion source 910. The sample ions pass through the high capacity transfer tube 915, electrodynamic ion funnel 920, and internal calibrant source 925, to be received at the beam guide 930. This passes the sample ions to enter the quadrupole mass filter 935, and move through the ion gate combined with charge detector 940 to the C-trap 945. The C-trap 945 stores the packet of sample ions, before injection into the chamber 105 of the IMS system 950. Once injected into the IMS system 950, ion mobility separation of the packet of sample ions may proceed as described above with respect to the examples of FIGS. 2 to 4, or FIG. 6. After ion mobility separation, ions having the same or similar mobility (e.g. ions of the same species separated from the packet of sample ions) can be ejected from the chamber 105 of the IMS system 950 back to the C-trap 945 and subsequently be passed to the mass analyser 955 for analysis.

It is noted that the described low-resolution example of the IMS system (with reference to FIGS. 2 to 4) allows for the ejection from the chamber of a first ion species of interest, with subsequent mobility separation (and ejection) of further ion species of interest within the remaining sample ions within the chamber. In this scenario, the further ion species may be ejected from the IMS system 950 and passed to the mass analyser 960, thus allowing multiple species from the initial packet of sample ions to be analysed.

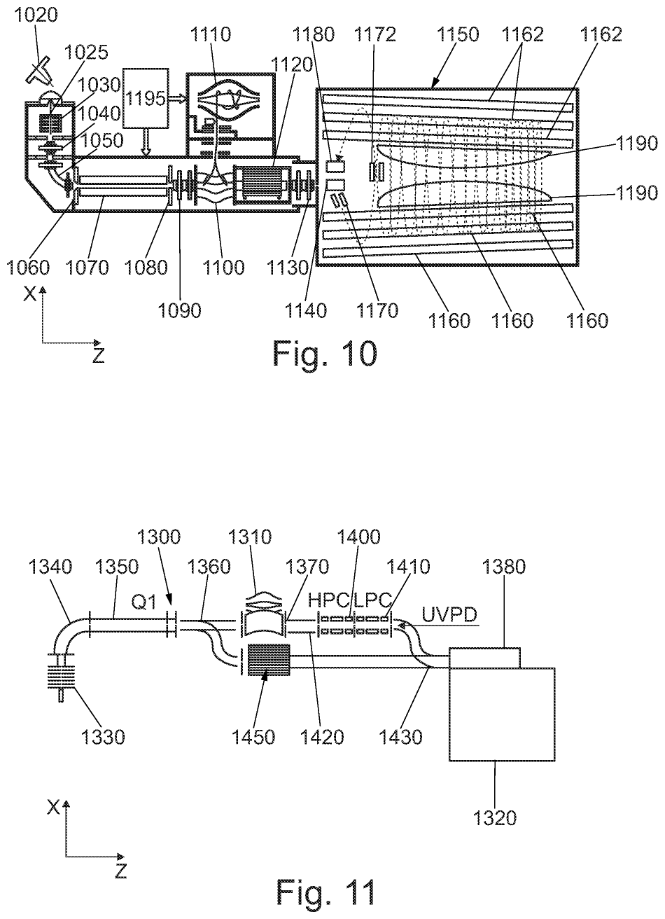

FIG. 10 shows an example of the described IMS systems as a part of a hybrid quadrupole/Orbitrap/multi-reflection time-of-flight mass spectrometer of the type detailed in US Patent Publication 10,699,888 (herein incorporated by reference). Looking to FIG. 10, a sample to be analysed is supplied (for example, from an autosampler) to a chromatographic apparatus such as a liquid chromatography (LC) column (not shown in FIG. 10). In the LC column, sample molecules elute at different rates according to their degree of interaction with a stationary phase, thereby separating different sample species.

Separated sample molecules received from the chromatographic apparatus are passed to an electrospray ionisation source 1020, at which the molecules are ionised. The sample ions then enter a vacuum chamber of the mass spectrometer and are directed by a capillary 1025 into an RF-only S lens 1030. The ions are focused by the S lens 1030 into an injection flatapole 1040 which injects the ions into a bent flatapole 1050 with an axial field for guiding the ions along a curved path.

An ion gate 1060 is located at the distal end of the bent flatapole 1050 and controls the passage of the ions from the bent flatapole 1050 into a downstream mass selector in the form of a quadrupole mass filter 1070. The quadrupole mass filter 1070 serves as a band pass filter, allowing passage of a selected mass number or limited mass range while excluding ions of other mass to charge ratios (m/z). The mass filter can also be operated in an RF-only mode in which it is not mass selective, i.e. it transmits substantially all m/z ions. Although a quadrupole mass filter is shown in FIG. 10, the skilled person will appreciate that other types of mass selection devices may also be suitable for selecting precursor ions within the mass range of interest.

Ions then pass through a quadrupole exit lens/split lens arrangement 1080 and into a first transfer multipole 1090. The first transfer multipole 1090 guides the mass filtered ions from the quadrupole mass filter 1070 into a curved linear ion trap (C-trap) 1100. Cooled ions are ejected from the C-trap towards a first mass analyzer 1110. As shown in FIG. 10, the first mass analyzer is an orbital trapping mass analyzer 1110, for example an Orbitrap mass analyzer by Thermo Fisher Scientific, Inc. Within the Orbitrap mass analyser, ions are separated on frequency in accordance with their mass to charge ratio and detected by use of an image detector. From the peaks recorded at the image detector, a mass spectrum, representing abundance/ion intensity versus m/z, can be produced.

In a second mode of operation of the C-trap 1100, ions passing through the quadrupole exit lens/split lens arrangement 1080 and first transfer multipole 1090 into the C-trap 1100 may continue their path into an IMS system 1120 of the type described above with respect to FIG. 2 to 4, 6 or 8. The IMS system can be used for fragmentation of ions, for example by applying appropriate voltage offsets between the C-trap 1100 and IMS system 1120 to impart sufficient energy to the ions entering the IMS system to cause fragmentation. Moreover, the IMS system can be used for further separation of ions according to their ion mobility (via the processes described above), which was not possible in previous systems using a fragmentation cell in this position, such as the system described in US Patent Publication No. 10,699,888. When operated as a fragmentation system, the IMS system can be used for separation of the produced fragment ions according to their ion mobility.

Fragmented ions may be ejected from the IMS system 1120 at the opposing axial end to the C-trap 100. The ejected fragmented ions pass into a second transfer multipole 1130 into an extraction trap (second ion trap) 1140. The extraction trap 1140 is provided to form an ion packet of fragmented ions, prior to injection into the multi-reflection time-of-flight mass analyser 1150 for generation of mass spectra.

FIG. 10 further illustrates features of the time-of-flight mass analyser 1150 such as opposing ion mirrors 1160,1162; additional ion deflectors 1170, 1172; ion detector 1180; stripe electrode 1190; and, a controller 1195. The folded ion beam path through the time-of-flight mass analyser 1150 is shown by the dotted line.

A further alternative embodiment for implementation of the IMS system is disclosed in FIG. 11. This is an alternative embodiment of a hybrid quadrupole/Orbitrap/multi-reflection time-of-flight mass spectrometer as described in US Patent Publication 10,699,888. FIG. 11 depicts a schematic diagram of a tandem mass spectrometer 1300 including an orbital trapping mass analyser 1310 and a time-of-flight mass analyser 1320 in a branched path configuration.

FIG. 11 shows an ion source 1330 and ion guide 1340 which supply precursor ions to a mass selector 1350 for mass isolation. Such an arrangement may be provided by the electrospray (ESI) ion source 1020 and its respective couplings to the quadrupole mass filter 1070 as shown in the embodiment of FIG. 10 for example. It will be appreciated that other ion sources than ESI, such as matrix-assisted laser desorption/ionization (MALDI) for example, can be used to generate the ions where that is more applicable to the types of samples being ionised.

A first branch of a branched ion path 1360 guides ions from the mass selector 1350 to a C-trap 1370. The C-trap 1370 supplies ions to the orbital trapping mass analyser 1310 for recording first mass spectra. The first branch may also guide ions through the C-trap to an extraction trap 1380, which supplies ions to the time-of-flight mass analyser 1320 for recording second mass spectra, optionally in parallel to the first mass spectra.

The first branch additionally includes a dual linear trap 1400, 1410. The dual linear trap is connected downstream of the C-trap 1370 between the C-trap 1370 and the extraction trap 1380 for the time-of-flight mass analyser. The dual linear trap may be connected to the C-trap 1370 and the extraction trap 1380 by ion guides 1420, 1430. The dual linear trap 1400, 1410 may be provided for fragmentation and/or mass isolation of the ions.

A second branch of the ion path passes to the extraction trap 1380 from the mass selector 1350, via an IMS system 1450 as described above in FIGS. 2 to 4, 6 and 8. This allows ions (including mobility separated ions) to be more efficiently transferred from the mass selector 1350 to the extraction trap. This second branch provides a bypass for sample ions, which can be used to avoid any conflict with operations carried out in the C-trap and collision cell. An IMS system installed in this bypass (as shown in FIG. 11) enables selection of ions of interest by ion mobility or storage of certain ions of the sample ions. Selected ions of different mobilities (or fragments of the same) can then be successively ejected to the downstream time-of-flight mass analyser.

In the examples of FIGS. 9, 10 and 11, the described IMS system replaces an ion routing multipole or collision (fragmentation) cell and incorporates all its functions whilst enabling ion selection based on ion mobility.

Overall, the following modes of operation for the described IMS system are available:
1. The described high-resolution examples (in FIGS. 6 and 8) where the total drift length is L_{drift}×N (where N is the number of passes), while the ion mobility range is reduced by factor greater than N.
2. In the described low-resolution mode (in FIGS. 2 to 4), ions can be separated only with few reflections in the deflection regions. The ions of interest can be transferred to the trap (e.g. a C-trap or extraction trap) from which they can be ejected into the mass analyser (Orbitrap or time-of-flight mass analyser), or any device downstream. This is especially useful for charge-state selection of molecules e.g. peptides.
3. In multiplexed mode, different or the same ions with selected mobilities can be stored in an optional ion storage region (as shown as 132 in FIG. 4, for instance). This occurs by lowering the potential well of the storage region to accept each subsequent mobility separated ion. In part, this is possible due to the ability of the currently described system to provide a drift trajectory that is perpendicular to the direction of injection of ions into the ion mobility separation chamber. After storage of certain mobility selected ions, all co-added populations can be detected together in a single mass spectrometry acquisition. This is a useful method for top-down analysis of proteins of different charge states, for instance.
4. An important particular case of multiplexed mode is a linked quadrupole-ion mobility spectrometry scan. In this case, the quadrupole mass filter selects a particular narrow m/z region for which a narrow range of mobilities is then selected, in order to select a particular chemical class of compounds or a particular charge state or multiple charge states of the same molecule (e.g. protein) to pass to a mass analyser. Although the switching of a quadrupole mass filter takes less than 1-2 ms, this is sufficient to achieve low to medium resolution in the described IMS system and is adequate for this application. This is the method of choice for chemical class selection in proteomics, metabolomics, lipidomics and complex mixtures.
5. In a fragmentation mode, an offset of the storage region (for example, 132 of FIG. 4) could be raised sufficiently high relative to the IMS region that the sample ions experience fragmentation in the drift region once they are released. This process could be followed by a period of ion mobility separation. Alternatively, sample ions can be fragmented on entry to the chamber, and then the fragments subjected to ion mobility separation according to the process described above with respect to the various examples of the IMS system. It can be seen from FIGS. 9, 10 and 11 generally that systems having a quadrupole-IMS-time-of-flight (Q-IMS-TOF) configuration are possible. In this way, fragmentation of ions of the same m/z but different mobility is possible.
6. In a transmission mode, ions are allowed to drift along the device in a quasi-continuous manner, being pulled by the axial field along the device in the direction Z.
7. Two-dimensional separation wherein ions of particular mobility are first selected under a low electric field according to collisional cross-section and then separated under a high electric field according to non-linear mobility.

Multiple stages of mass and/or mobility analysis are also possible (e.g. MS2, MS3 etc.). Such mass spectrometry data may be acquired on the systems described herein using data dependent and/or data independent acquisition modes.

A further mode of operation for the described IMS system is envisaged and hereafter described. This mode represents a continuously operating ion mobility filter, and is described with reference to the chamber illustrated in FIG. 2(a), FIG. 3 and FIG. 4(a). In this mode, sample ions are continuously received through the inlet 120 to the chamber and as a result of an axial potential provided by DC only electrodes 116 then move in the direction of the Z-axis.

As can be seen in FIG. 3 and FIG. 4(a), the initial portion (in the region 124a) of the trajectory of sample ions moving in the direction of the Z-axis from the inlet 120 does not pass directly between mixed electrodes 114. Once the sample ions reach the portion of the chamber between mixed electrodes 114, potential at the mixed electrodes 114 cause the ions to be moved back and forth through the drift region 110 (in particular, along drift trajectories in the direction between the first 112a and the second 112b deflection regions). As before, the sample ions separate according to their ion mobility on each pass through the drift region 110. The frequency (or speed) at which the successive passes through the drift region are made will be tuned according to the mobility of the ions of interest for analysis, and the sizes of the chamber.

In this mode of operation, the ions of interest for analysis (i.e. to be filtered out to be passed to a mass analyser) do not reach the deflection (or reflection) regions 112a, 112b after each pass through the drift region 110. Instead, the ions of interest stay within the drift region 110, although their direction of movement is still changed to move back and forth through the drift region. Upon each pass thought the drift region 110 (or more specifically, upon interaction with the DC only electrodes 116 at each pass), the ions are moved closer to the outlet 122 of the chamber by application of an appropriate potential. As such, each successive trajectory through drift region 110 (i.e. each drift trajectory) at the point when it crosses the Z-axis is closer to the outlet than the previous trajectory through drift region 110. As a result, as they near the point where the ions move out of the region between the mixed electrodes 114 closest to the chamber outlet 122, the ions for analysis, separated from other ions within the original sample, coalesce towards, or to the close vicinity of, the Z-axis. Subsequently, appropriate potentials applied at the DC only electrodes 116 in the region 124b of the chamber between the mixed electrodes 114 and the outlet 122 causes said separated ions for analysis to be ejected from the chamber through the outlet 122.

In this mode, by appropriate choice of potentials on mixed electrodes 114, sample ions of higher mobility than the ions of interest can be allowed to reach the deflection (or reflection) regions 112a, 112b during the change of direction of the ions, even where the ions of interest are retained within the drift region 110. Said higher mobility ions reaching the deflection regions 112a, 112b can be allowed to be lost or absorbed there, and so filtered out of the sample ions within the chamber. As noted above, in this mode of operation only ions precisely on the Z-axis at the point of entry to the region 124b of the chamber between the mixed electrodes 114 and the outlet 122 would be directed out of the chamber through the outlet 122, whilst other ions can be absorbed (defocused), or further reflected or stored to continue the ion filtering process. In this way, the ions of interest are filtered out and leave the chamber through outlet 122, as the ions of interest (having a particular mobility) are positioned at the centre of the chamber on the Z-axis at the point of entry to region 124b of the chamber. In contrast, ions having a mobility other than the ion of interest would be spread along the X-axis across mixed electrodes 114 at the point of entry to the region 124b, after which they may pass onto the walls of the chamber 105. Alternatively, if a positive voltage is applied to the wall of the chamber and there is continued oscillation of the potential gradient in the X-axis, then the ions having a mobility other than the ion of interest in the region 124b may be absorbed or extracted at the extremes of the DC only electrodes 116.

It will be understood that the above described mode of operation operates with the same pressure requirements for the chamber as discussed in earlier portions of this disclosure. In particular, the chamber will be maintained at lower than atmospheric pressure, preferably much lower than atmospheric pressure, with a substantially homogenous pressure throughout the chamber. In particular, the pressure in the drift region and each of the deflection regions is substantially the same (within the same order of magnitude), and may be less than 500 mBar, or even less than 100 mBar, or less than 50 mBar, or less than 10 mBar. Some minor variation of pressure may be possible when comparing the region of the chamber nearest the pumping aperture and the distant extents of the chamber. However, this variation will be minimal and vary smoothly without any sharp steps or sudden changes in the pressure. The highest pressure region of the chamber will be no more than 10 times the lowest pressure region of the chamber, so that the pressure throughout the chamber varies by no more than an order of magnitude. Significantly, any change of pressure experienced by a sample ion (specifically the ions of interest) over one mean free path is much smaller (being 10%, 5% or even 1%) of the absolute magnitude of the average pressure within the chamber.

In view of the discussion of all modes of operation above, it will be understood that a number of benefits can be provided by the described IMS system. These benefits include:

Lossless ion mobility separation in the low-resolution system (described above with reference to FIGS. 2, 3 and 4). The low resolution system potentially offers 100% utilization of ions, including the possibility of wide range accumulation and sequential ejection.

Orders of magnitude increased space charge capacity, in view of the ability to have a chamber (and more particularly a drift region shaped as a prism having axial symmetry of order 2, such as rectangular prism).

Reduced vacuum requirements compared to previously described systems, such as the system in Patent Publication US 2016/084799, as the pressure in the chamber can be substantially the same throughout (including within the drift and deflection regions).

The described IMS systems can be combined with a collision cell and ion routing device.

The described IMS systems provide a rapid scan time.

The described IMS systems can operate in the high-field regime (and so in a regime where field-dependent ion mobility is not directly linked to the ion cross-section, but linked to the ion molecular structure).

The described IMS systems provide new modes of separation, for instance two-dimensional separation with high sensitivity to structural difference in molecules.

The described IMS systems provide multiple drift stages, thereby increasing the length of the drift region in a compact manner.

A number of combinations of the various described embodiments could be envisaged by the skilled person. All of the features disclosed herein may be combined in any combination, except combination where at least some such features and/or steps are mutually exclusive. In particular, the preferred features of the invention are applicable to all aspects of the invention and may be used in any combination. Likewise, features described in non-essential combinations may be used separately (not in combination). The mean free path of an ion, mfpᵢₒₙ, is considered above compared to the length of the drift trajectory, L_{drift}, and the length of the deflection trajectory, L_{deflection}. The mean free path of an ion, mfpᵢₒₙ, corresponds to the length of momentum loss of an ion of cross-section σ by e-times. In other words:

$$m f {p}_{i o n} = ( \frac{M + m}{m} ) ( \frac{1}{n \sqrt{{σ}^{2} + {σ}_{ℊ}^{2}}} )$$

where m is the mass of a gas molecule, and M the mass of a given ion.

Although the mean free path of an ion, mfpᵢₒₙ is used generally in the description above, it will be understood that the stopping length of an ion could instead be used. The stopping length is the path length over which there is a complete loss of momentum of the ion, and so the ion is thermalized to energy kT. The stopping length stopLᵢₒₙ for an ion of mass M and initial velocity u in buffer gas of mass m, density n, average thermal velocity v and cross-section a can be calculated approximately as

$$stop {L}_{i o n} = mf {p}_{i o n} \cdot constant = \frac{M + m}{mn σ} \cdot \frac{3 √ 5}{4} arctan ( \frac{u}{v √ 5} )$$

(see A. V. Tolmachev et al., NIM Phys Res. B, 124 (1997) 112-119).

1. A method of ion mobility spectrometry comprising:
introducing a packet of sample ions into a chamber, the sample ions including an ion for analysis and the chamber housing a drift region and a deflection region;
passing the sample ions on a drift trajectory through the drift region towards the deflection region, wherein the sample ions separate according to their ion mobility as they pass through the drift region; and
passing the sample ions received from the drift region on a deflection trajectory through the deflection region whilst changing the direction of the sample ions on the deflection trajectory to travel towards the same drift region or a further drift region;
wherein the chamber is maintained at a pressure that is substantially homogeneous throughout the chamber, the pressure being such that the mean free path of the ion for analysis is greater than the length of the deflection trajectory, and less than the length of the drift trajectory.

2. The method according to claim 1, wherein a highest pressure region in the chamber is no more than 10 times a lowest pressure in the region of the chamber.

3. The method according to claim 1, wherein the method further comprises accelerating the sample ions upon entry to the deflection region, wherein the sample ions are accelerated to an energy greater than kT, where k is the Boltzmann constant and T is temperature, but below the fragmentation energy of the sample ions.

4. The method according to claim 1, wherein the drift region is defined within the volume of the chamber such that the drift region has a greater extension in a first direction orthogonal to the direction of the drift trajectory than compared to a second direction orthogonal to the direction of the drift trajectory, wherein the first and second direction are orthogonal to each other.

5. The method according to claim 1, wherein changing the direction of the sample ions on the deflection trajectory comprises reflecting the sample ions on the deflection trajectory towards the drift region to travel on a second drift trajectory through the drift region, such that the sample ions pass through the drift region at least twice.

6. The method according to claim 1, wherein the deflection region is a first deflection region and the chamber further houses a second deflection region, opposite the first deflection region with the drift region extending there between, and wherein the drift trajectory is a first drift trajectory and the deflection trajectory is a first deflection trajectory;
wherein changing the direction of the sample ions on the deflection trajectory comprises reflecting the sample ions on the first deflection trajectory towards the drift region;
the method further comprising:
passing the sample ions on a second drift trajectory through the drift region towards the second deflection region, wherein the sample ions further separate according to their ion mobility as they pass through the drift region on the second drift trajectory; and
passing the sample ions received from the drift region on a second deflection trajectory through the second deflection region whilst reflecting the sample ions on the second deflection towards the drift region;
wherein the chamber is maintained at a pressure such that the mean free path of the ion for analysis is greater than the length of the first or the second deflection trajectory, and less than the length of the first or the second drift trajectory.

7. The method according to claim 1, wherein the drift region is a first drift region and the chamber further houses a second drift region, the deflection region is a first deflection region and the chamber further houses a second deflection region, opposite the first deflection region with the first and the second drift region extending there between and the first and second drift region extending parallel to each other, and wherein the drift trajectory is a first drift trajectory and the deflection trajectory is a first deflection trajectory;
wherein changing the direction of the sample ions on the deflection trajectory comprises changing the direction of the sample ions on the first deflection trajectory to travel towards the second drift region;
the method further comprising:
passing the sample ions on a second drift trajectory through the second drift region towards the second deflection region, wherein the sample ions further separate according to their ion mobility as they pass through the second drift region on the second drift trajectory, and such that sample ions passing through the second drift region on a second drift trajectory travel in a direction that is substantially parallel but opposite to sample ions passing through the first drift region on the first drift trajectory; and
passing the sample ions received from the second drift region on a second deflection trajectory through the second deflection region whilst changing the direction of the sample ions from the second deflection trajectory towards the first drift region;
wherein the chamber is maintained at a pressure such that the mean free path of the ion for analysis is greater than the length of the first or the second deflection trajectory, and less than the length of the first or the second drift trajectory.

8. The method according to claim 1, wherein the drift trajectory is a first drift trajectory, the deflection region is a first deflection region, the deflection trajectory is a first deflection trajectory, and the chamber houses at least the first drift region and a second and a third drift region, and the first and a second deflection region, wherein changing the direction of the sample ions comprises:
changing the direction of the sample ions on the first deflection trajectory to travel towards a second drift region;
the method further comprising:
passing the sample ions on a second drift trajectory through the second drift region towards a second deflection region, wherein the sample ions further separate according to their ion mobility as they pass through the second drift region; and
passing the sample ions received from the second drift region on a second deflection trajectory whilst changing the direction of the sample ions on the second deflection trajectory to travel towards the third drift region;
wherein the chamber is maintained at a pressure such that the mean free path of the ion for analysis is greater than the length of the first or second deflection trajectory, and less than the length of the first or second drift trajectory.

9. The method according to claim 1, wherein the method further comprises passing the sample ions through each drift region and each respective deflection region multiple times.

10. The method according to claim 1, wherein for each pass through a given drift region, the sample ions undergo a thermalisation phase and a drift phase, and for each pass through a respective deflection region, the sample ions undergo a ballistic deflection phase.

11. The method according to claim 10, wherein the sample ions further undergo an acceleration phase between the drift phase and the ballistic deflection phase.

12. The method according to claim 1, further comprising ejecting the ions for analysis out of the chamber, wherein ions for analysis ejected out of the chamber are passed to a mass analyser.

13. An ion mobility spectrometer comprising:
a chamber housing a drift region and a deflection region, the deflection region comprising ion optics to change the direction of ions passing through the deflection region; and
a pump, connected to the chamber for pumping the drift region and the deflection region housed within the chamber;
wherein the drift region is arranged to receive sample ions introduced to the chamber, the sample ions including an ion for analysis, the drift region arranged such that the sample ions pass on a drift trajectory through the drift region and separate according to their ion mobility as they pass through the drift region; and
wherein the deflection region is arranged to receive sample ions from the drift region to travel on a deflection trajectory through the deflection region, and the ion optics are configured to change the direction of the sample ions on the deflection trajectory to travel towards the same drift region or a further drift region;
wherein in use the chamber is maintained at a pressure that is substantially homogeneous throughout the chamber, the pressure being such that the mean free path of the ion for analysis is greater than the length of the deflection trajectory, and less than the length of the drift trajectory.

14. The ion mobility spectrometer according to claim 13, wherein the pump is arranged so that in use the highest pressure region of the chamber is no more than 10 times the lowest pressure region of the chamber, wherein the pump is arranged to pump the drift region and the deflection region simultaneously.

15. The ion mobility spectrometer according to claim 13, wherein the ion optics are further configured to accelerate the sample ions upon entry to the deflection region, wherein the ion optics are configured to accelerate the sample ions to an energy greater than kT, where k is the Boltzmann constant and T is temperature, but below the fragmentation energy of the sample ions.

16. The ion mobility spectrometer according to claim 13, wherein the drift region is defined within the volume of the chamber such that the drift region has a greater extension in a first direction orthogonal to the direction of the drift trajectory than compared to a second direction orthogonal to the direction of the drift trajectory, wherein the first and second direction are orthogonal to each other.

17. The ion mobility spectrometer according to claim 13, wherein in use the ion optics are configured to change the direction of the sample ions on the deflection trajectory to reflect the sample ions towards the same drift region.

18. The ion mobility spectrometer according to claim 13, wherein the chamber houses a first and second drift region and wherein the deflection region is arranged to receive sample ions from the first drift region, and the ion optics are configured to change the direction of the sample ions on the deflection trajectory to travel towards the second drift region.

19. The ion mobility spectrometer according to claim 13, wherein, in use the chamber is filled with a buffer gas.

20. The ion mobility spectrometer according to claim 16, wherein the chamber further comprises an outlet, arranged to allow ions for analysis to be ejected out of the chamber via the outlet, wherein ions ejected out of the chamber via the outlet are passed to a mass analyser.
